(19) United States
(12) Patent Application Publication
(10) Pub. No.: US 2018/0025309 A1
(43) Pub. Date: Jan. 25, 2018

(54) SHIFT WORKER PLATFORM

(71) Applicant: ShiftPixy, Inc., Irvine, CA (US)

(72) Inventors: Scott William Absher, Laguna Hills, CA (US); John Stephen Holmes, Irvine, CA (US); Timothy John Wales, Chandler, AZ (US)

(21) Appl. No.: 15/658,336

(22) Filed: Jul. 24, 2017

Related U.S. Application Data
(60) Provisional application No. 62/366,548, filed on Jul. 25, 2016.

(51) Int. Cl. G06Q 10/06

(52) U.S. Cl. CPC G06Q 10/063116; G06Q 10/063112; G06F 3/04817

(57) ABSTRACT

Operations of a shift worker platform include receiving a shifter designation command designating an employee of a common employer entity to become one of a plurality of shifters and receiving available shift data generated using an interactive job provider client calendar, the available shift data representing an available work shift of a job provider client of the common employer entity. The operations further include establishing one or more matches between the available shift data and the plurality of shifters, updating an interactive shifter calendar of each of the matching shifters to include a visual representation of the available work shift, and receiving shift selection data generated using the shifter calendar of one of the matching shifters, the shift selection data including a selection of the available work shift by the shifter. The operations further include updating the job provider client calendar to include a visual representation of the selection.

### CROSS-REFERENCE TO RELATED APPLICATIONS

This application relates to and claims the benefit of U.S. Provisional Application No. 62/366,548 filed on Jul. 25, 2016, the contents of which is expressly incorporated by reference herein.

### STATEMENT RE: FEDERALLY SPONSORED RESEARCH/DEVELOPMENT

Not Applicable

### BACKGROUND

The various embodiments and aspects discussed herein relate to a shift worker platform for use by a common employer entity (“CEE”).

In some industries, like the food industry, the workforce needs of individual job providers may be highly unstable even though the workforce needs of the industry at large are stable. For example, a particular bar or restaurant may have a slow night while a similar bar or restaurant across town (or even across the street) has a line out the door. A bartender might be told to go home early and lose out on pay, or the bartender might be paid at a loss to the business owner, even though there are other nearby businesses that could use the extra work.

### BRIEF SUMMARY

The present disclosure contemplates various systems and methods for overcoming the above drawbacks accompanying the related art. A common employer entity (“CEE”) provides or subscribes to a shift worker platform enabling interactive calendar access to job provider clients of the CEE and shifters using the shift worker platform. The CEE may act as the sole employer of the workforce of each of its job provider clients. The shift worker platform allows an employee that previously worked exclusively for one job provider to work a shift for another job provider when the employee would otherwise not be needed. In this way, the employee may fill her work schedule (e.g. forty hours in a week) in order to make a living. From the perspective of a job provider, the shift worker platform allows the job provider to retain good employees even when the job provider cannot offer many hours or a stable schedule. Using the shift worker platform, the job provider may flexibly increase or decrease workforce size on a shift-by-shift basis without sacrificing efficiency or employee quality.

A job provider client of the CEE may designate a portion of its workforce to enter a shifter pool. Those employees so designated are released from any restrictions to work exclusively for the job provider and are allowed to apply for work shifts of other job providers. When a job provider client of the CEE wishes to post an available work shift, the job provider client accesses an interactive job provider client calendar via a mobile, Web, or other application (e.g. a cloud-based calendar) and interacts with the calendar to designate the available work shift. The available work shift may include, for example, a date and time slot and required shifter qualifications. The job provider client's user interaction with the calendar generates data representing the available work shift. The CEE-side application receives the data and compares it with the qualifications of shifters to establish one or more matches. The CEE-side application then updates an interactive shifter calendar of each matching shifter to include a visual representation of the available work shift. When the matching shifters access the shifter calendar, they see the available work shift. If a shifter wants to work that shift, the shifter interacts with the calendar (e.g. in the cloud) to select the available work shift using a mobile, Web, or other application. The shifter's user interaction with the calendar generates data representing the selection, which is then received by the CEE-side application. The CEE-side application may then update the job provider client calendar to include a visual representation of the shifter's selection. The job provider client may then see, for example, that the work shift has been filled by the shifter or that the shifter has applied to fill the work shift. The shift worker platform may further support subsequent selection of the shifter by the job provider client and confirmation by the shifter.

The shift worker platform allows the CEE to implement a highly efficient service structure in which similarly skilled employees of the CEE are effectively “shared” between multiple job provider clients. This is especially useful in industries where job skills and qualifications are readily transferable between job providers. In some such industries, as noted above, the workforce needs of individual employers may be unstable even though the workforce needs of the industry at large are stable. By using the shift worker platform, the CEE may allow job provider clients to flexibly increase or decrease the size of their workforces on a temporary basis, while allowing shifters to fill shifts of multiple job providers as they become available. The risks associated with unstable workforce needs can thus be reduced for job providers and employees alike.

More particularly, one aspect of the embodiments of the present disclosure is a non-transitory program storage medium on which are stored instructions executable by a processor or programmable circuit to perform operations. The operations include receiving a shifter designation command designating an employee from among a plurality of employees of a common employer entity to become one of a plurality of shifters and receiving available shift data generated by user interaction with an interactive job provider client calendar, the available shift data representing an available work shift of one of a plurality of job provider clients of the common employer entity. The operations further include establishing one or more matches between the available shift data and the plurality of shifters, updating an interactive shifter calendar of each of the plurality of shifters for whom a match was established to include a visual representation of the available work shift, and receiving shift selection data generated by user interaction with the shifter calendar of a first shifter of the plurality of shifters for whom a match was established, the shift selection data including a selection of the available work shift by the first shifter. The operations further include updating the job provider client calendar to include a visual representation of the selection by the first shifter.

Another aspect of the embodiments of the present disclosure is a method including receiving a shifter designation command designating an employee from among a plurality of employees of a common employer entity to become one of a plurality of shifters and receiving available shift data generated by user interaction with an interactive job provider client calendar, the available shift data representing an available work shift of one of a plurality of job provider clients of the common employer entity. The method further includes establishing one or more matches between the available shift data and the plurality of shifters, updating an interactive shifter calendar of each of the plurality of shifters for whom a match was established to include a visual representation of the available work shift, and receiving shift selection data generated by user interaction with the shifter calendar of a first shifter of the plurality of shifters for whom a match was established, the shift selection data including a selection of the available work shift by the first shifter. The method further includes updating the job provider client calendar to include a visual representation of the selection by the first shifter.

Another aspect of the embodiments of the present disclosure is a system including a job provider I/O interface for receiving a shifter designation command designating an employee from among a plurality of employees of a common employer entity to become one of a plurality of shifters and receiving available shift data generated by user interaction with an interactive job provider client calendar, the available shift data representing an available work shift of one of a plurality of job provider clients of the common employer entity. The system further includes a server for establishing one or more matches between the available shift data and the plurality of shifters and updating an interactive shifter calendar of each of the plurality of shifters for whom a match was established to include a visual representation of the available work shift and a shifter I/O interface for receiving shift selection data generated by user interaction with the shifter calendar of a first shifter of the plurality of shifters for whom a match was established, the shift selection data including a selection of the available work shift by the first shifter. The server updates the job provider client calendar to include a visual representation of the selection by the first shifter.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows an overview of an environment in which a shift worker platform according to an embodiment of the present disclosure may be implemented;

FIG. 2 shows an example user interface including an interactive job provider client calendar;

FIG. 3 shows an example user interface including an interactive shifter calendar;

FIG. 4 shows an example shift worker platform according to an embodiment of the present disclosure;

FIG. 5 shows an overview of an example operational flow of the shift worker platform;

FIG. 5A shows a first part of the example operational flow of FIG. 5;

FIG. 5B shows a second part of the example operational flow of FIG. 5;

FIG. 5C shows a third part of the example operational flow of FIG. 5;

FIG. 5D shows a fourth part of the example operational flow of FIG. 5;

FIG. 5E shows a fifth part of the example operational flow of FIG. 5;

FIG. 5F shows a sixth part of the example operational flow of FIG. 5;

FIG. 5G shows a seventh part of the example operational flow of FIG. 5;

FIG. 5H shows an eighth part of the example operational flow of FIG. 5;

FIG. 5I shows a ninth part of the example operational flow of FIG. 5;

FIG. 5J shows a tenth part of the example operational flow of FIG. 5;

FIG. 5K shows an eleventh part of the example operational flow of FIG. 5;

FIG. 5L shows a twelfth part of the example operational flow of FIG. 5;

FIG. 5M shows a thirteenth part of the example operational flow of FIG. 5;

FIG. 5N shows a fourteenth part of the example operational flow of FIG. 5;

FIG. 5O shows a fifteenth part of the example operational flow of FIG. 5;

FIG. 6A shows an example user interface view that may be accessed by a job provider client using the shift worker platform according to an embodiment of the present disclosure;

FIG. 6B shows another example user interface view that may be accessed by a job provider client using the shift worker platform according to an embodiment of the present disclosure;

FIG. 6C shows another example user interface view that may be accessed by a job provider client using the shift worker platform according to an embodiment of the present disclosure;

FIG. 7A shows an example user interface view that may be accessed by a shifter using the shift worker platform according to an embodiment of the present disclosure;

FIG. 7B shows another example user interface view that may be accessed by a shifter using the shift worker platform according to an embodiment of the present disclosure; and

FIGS. 8A and 8B show an example of a computer in which the server of FIG. 1, the shift worker platform of FIG. 4, the operational flows of FIGS. 5A-5O, and/or other embodiments of the claimed invention may be wholly or partly embodied, with FIG. 8A showing a computer and FIG. 8B showing a block diagram of a system unit.

### DETAILED DESCRIPTION

Referring now to the drawings, an employment ecosystem is disclosed wherein a plurality of job provider clients can offer shifts to a plurality of shifters and the shifters can search for offered shifts and apply to work for shifts through a shift worker platform. In the employment ecosystem, all of the shifters may be employees of a common employer entity (“CEE”). Job provider clients may subscribe, join in, or become members of the shift worker platform operated by or offered by the CEE. This employment ecosystem allows the job provider clients to better accommodate changes in staffing needs of the job provider clients such as when one of its employees takes an unexpected paid leave, vacation days, sick day or other absence from their normal shift because the job provider client can also hire shifters through the shift worker platform. Also, the employment ecosystem allows the shifters to fill up their work schedule with gainful employment from other job provider clients. For example, if the shifter works 30 hours per week at one job provider, the shifter may be able to find 10 more hours of work per week from a different job provider through the shift worker platform.

The CEE may be a traditional professional employer organization wherein the professional employer organization is the employer-of-record of employees of a business (i.e., job provider client). Typically, all of the employees of the business are employees of the professional employer organization and these employees work only for the business that hired them. In accordance with the employment ecosystem described herein, the business may allow some of its employees (e.g. part-time employees) to fill up their schedule by filling shifts of other businesses that may require the skills of the part-time employee. In some cases, shifters may also be able to become part of the employment ecosystem by signing up with the shift worker platform independent from a business.

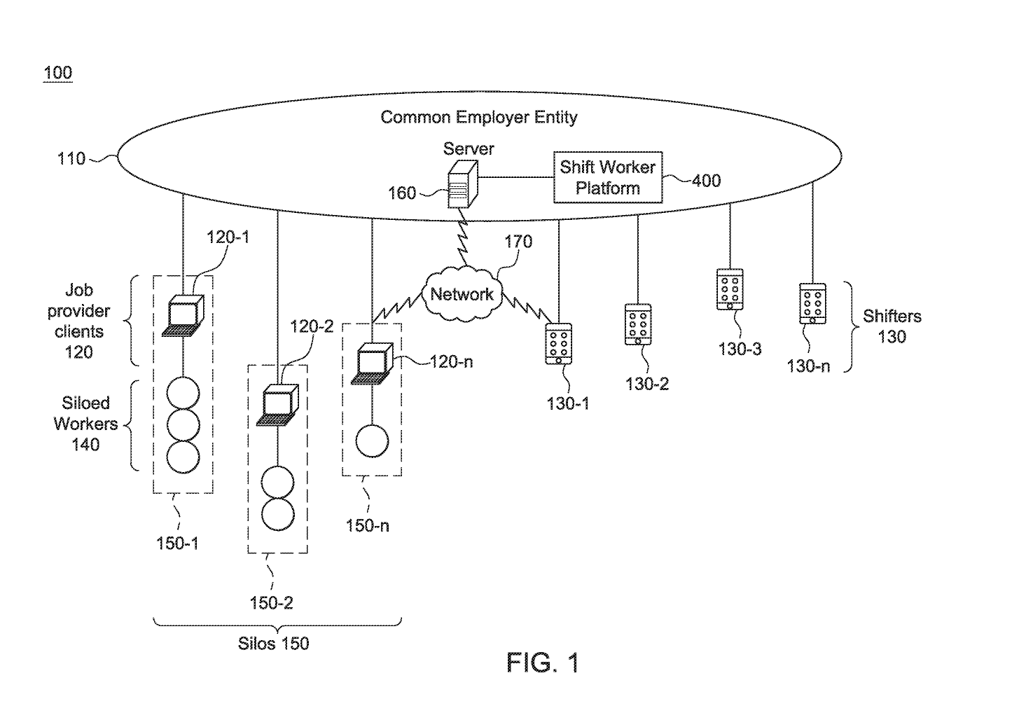

FIG. 1 shows an overview of an environment 100 in which a shift worker platform 400 according to an embodiment of the present disclosure may be implemented. A common employer entity (“CEE”) 110 has a plurality of job provider clients 120 (120-1, 120-2, . . . , 120-n) and a plurality of shifters 130 (130-1, 130-2, 130-3, . . . , 130-n). The job provider clients 120 may include “brick-and-mortar” businesses in the food industry (e.g. restaurants, bars, food delivery services), the health services industry (e.g. hospitals, pharmacies, prescription delivery), the construction industry, retail, or any other type of business, especially those whose workforce engages in jobs defined on a per-shift basis. The CEE 110 employs the workforces of each of the job provider clients 120 and may take on one or more employee management responsibilities such as payroll, human resources, overtime management, Affordable Care Act compliance, workers' compensation, and other legal, regulatory, and administrative responsibilities. The CEE 110 may be the sole employer on behalf of the job provider clients 120.

The shifters 130 may include workers, i.e. people, particularly those interested in engaging in jobs defined on a per-shift basis. The workforce of a given job provider client 120, while employed by the CEE 110, may be “siloed” with that particular job provider client 120. That is, the job provider clients 120 of the CEE 110 may be organized into a plurality of silos 150 (150-1, 150-2, . . . , 150n), each silo 150 including a single job provider client 120 and the workforce of that job provider client 120. The combined siloed workforces of the job provider clients 120 are illustrated in FIG. 1 as siloed workers 140, i.e. those workers who are contractually obligated to work exclusively for a single job provider. A job provider client 120 may release a portion of its workforce, allowing one or more siloed workers 140 to leave the silo 150 of the job provider client 120 and become one of the shifters 130 of the CEE 110. In this way, the shifters 130 may include the released (i.e. no longer siloed) workers of the job provider clients 120. The shifters 130 may further include workers who never were associated with one of the job provider clients 120 and instead engaged directly with the CEE 110. The shifters 130 are employed by the CEE 110. The employees of the CEE 110 therefore may include siloed workers 140 who are associated with job provider clients 120 as well as shifters 130 who are not associated with any of the job provider clients 120.

The environment 100 may further include a server 160 associated with the common employer entity 110 on which backend functionality of the shift worker platform 400 may be implemented. The shift worker platform 400 may be a cloud-based platform. The server 160 may be controlled by the common employer entity 110 or a third party offering the shift worker platform 400 to the common employer entity 110 as a service, e.g. a subscription-based service. The job provider clients 120 and shifters 130 may use the shift worker platform 400 by communicating with the server 160. For example, computing devices (computers, tablets, mobile phones, etc.) of the job provider clients 120 and shifters 130 may communicate with the server 160 via a network 170 such as the Internet using a mobile, Web, or other application. To this end, the computing devices may use a dedicated frontend application for accessing the shift worker platform 400 or may use a general purpose application such as a Web browser.

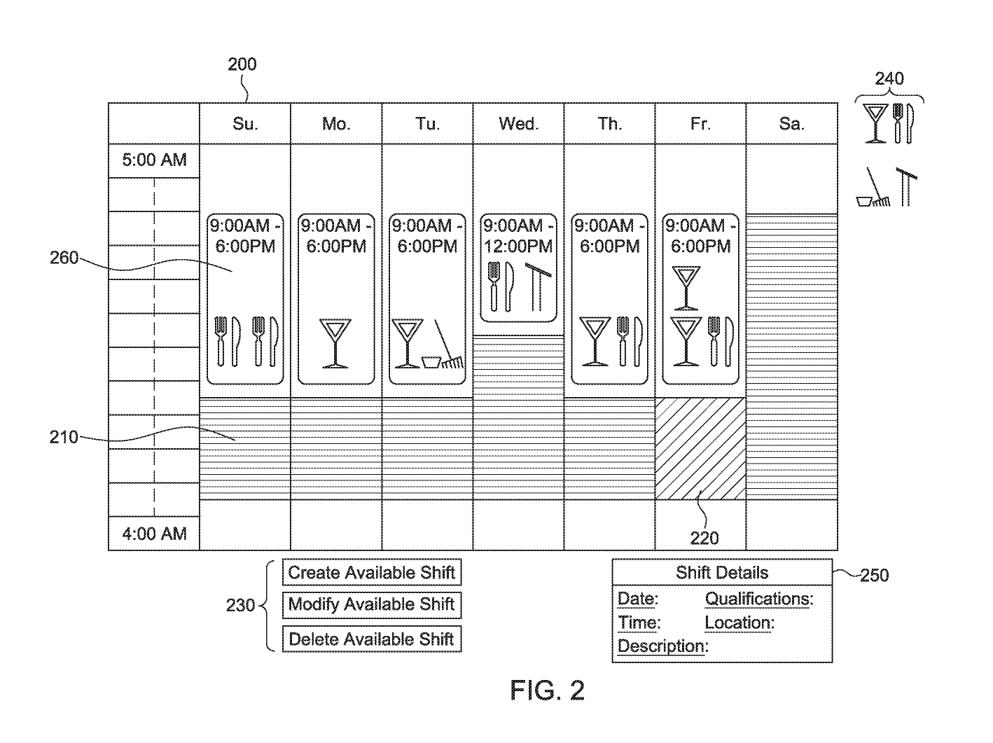

FIG. 2 shows an example user interface including an interactive job provider client calendar 200. When a job provider client 120 (e.g. a manager or other responsible party associated with a job provider client 120) accesses the shift worker platform 400, the job provider client calendar 200 may be one of a plurality of user interface views available to the job provider client 120, e.g. on a display of a computing device associated with the job provider client 120. The job provider client calendar 200 allows the job provider client 120 to easily see schedule gaps where shifts need to be filled and arrange for them to be filled by appropriate shifters 130. As shown in FIG. 2, the job provider client calendar 200 may be a weekly calendar arranged with columns representing the days of a week and rows representing time slots, e.g. hours. In the example shown in FIG. 2, the time slots run from 5:00 AM through 4:00 AM (24 hours) and the days run from Sunday through Saturday (7 days), but the job provider client calendar 200 may be customizable to limit the view to the hours of operation of the particular job provider client 120. The job provider client calendar 200 may include one or more filled shifts 210, one or more schedule gaps 220, a plurality of buttons 230, a job bank 240, a shift details panel 250, and one or more available shifts 260.

The filled shifts 210 represent hours of operation of the job provider client 120 during which no shifters 130 are needed. The filled shifts 210 may, for example, be shifts that have already been filled by shifters 130 or non-shifter workers (e.g. siloed workers 140) of the job provider client 120. In the example shown in FIG. 2, the filled shifts 210 are simply grayed out, but the filled shifts 210 may further include a display of information about the shift and the workers filling it and/or interactive buttons to manage or modify the filled shift 210.

The schedule gap 220 represents a time slot within the hours of operation of the job provider client 120 that has not been filled or has been vacated by the regular worker of that shift. The job provider client calendar 200 may highlight this time slot or otherwise make it conspicuous to the job provider client 120. Noticing the schedule gap 220, the job provider client 120 may select the schedule gap 220 (e.g. using a mouse, keyboard, touch panel, or other input device) and create an available shift 260 in the time slot of the schedule gap 220 using the buttons 230, the job bank 240, and/or the shift details panel 250. The buttons 230 may include, for example, a “create available shift” button that the user may press (click, tap, etc.) while the schedule gap 220 is selected in order to create an available shift 260. Creating the available shift 260 may cause the shift details panel 250 to appear or become populated with input fields associated with the recently created available shift 260. Similarly, a “modify available shift” button of the plurality of buttons 230 may bring up the shift details panel 250 for a selected available shift 260 that has previously been created. A “delete available shift” button of the plurality of buttons 230 may delete a previously created available shift 260, causing it to be replaced with a schedule gap 220.

While manual input of details in the shift details panel 250 is one contemplated method of defining the details of an available shift 260, the job provider client calendar 180 may support the automatic filling of input fields for enhanced usability. For example, date and time information of the available shift 260 to be created may be automatically determined from the calendar position of the selected schedule gap 220, while location information may be automatically filled based on a user profile of the job provider client 120 or narrowed down to a few choices (e.g. different branches of the business) based on the profile for easy selection using a dropdown menu. Through the use of the job bank 240, the job provider client calendar 180 may also support the automatic filling of more shift-specific input fields such as required qualifications to work the shift and job description. The job bank 240 may contain a plurality of icons representing predefined job profiles. In the example shown in FIG. 2, the job bank 240 contains a martini glass representing “bartender,” a fork and knife representing “server,” a mop and bucket representing “busser,” and a podium representing “host/hostess.” Each of these job profiles may be previously defined by the job provider client 120, including, for example, qualifications and job description of the respective job. The job provider client calendar 200 may include functionality to allow the job provider client 120 to simply drag and drop the icons of the desired job profiles into a schedule gap 220 (e.g. using mouse or touch input), thereby automatically creating an available shift 260 and auto-populating the shift details panel 250.

The job provider client calendar 200 shown in FIG. 2 shows available shifts 260 on Sunday, Monday, Tuesday, Wednesday, Thursday, and Friday in the form of rounded rectangular “bubbles.” Upon the creation of an available shift 260 at the time of the schedule gap 220, a similar rounded rectangular bubble may appear at that time (the Friday evening slot). Then, as each of the available shifts 260 becomes filled by a shifter 130, the bubble representing the available shift 260 may be replaced by the grayed out region representing a filled shift 210. Of course, these are only examples and many other visual appearances are possible to represent schedule gaps 220, available shifts 260, and filled shifts 210, preferably selected to be visually distinct for enhanced usability. As shown in FIG. 2, the available shifts 260 contain one or more job profile icons from the job bank 240. For example, two servers are needed for a Sunday 9:00 AM to 6:00 PM shift, a server and a host/hostess are needed for a Wednesday 9:00 AM to 12:00 PM shift, and two bartenders and a server are needed for a Friday 9:00 AM to 6:00 PM shift. To create the available shift 260 on Friday, the job provider client 120 may have simply dragged and dropped two martini glass icons and one fork and knife icon into a schedule gap 220 representing the 9:00 AM to 6:00 PM shift.

It is contemplated that the job profiles of the job bank 240 may include private parameters in addition to public parameters. That is, in addition to qualifications that a shifter 130 will see when applying for an available shift 260, there may be additional qualifications and/or priority settings for the available shift 260 that are hidden from the shifter 130. For example, a job provider client 120 may require two years of experience for a shift publicly while privately indicating a preference for more experience. This may be used by the shift worker platform 400 as described below in order to establish priority among multiple applicants for the same available shift 260. Similarly to the job profiles of the job bank 240, the shift details panel 250 may include input fields for manual input of private parameters in addition to public parameters.

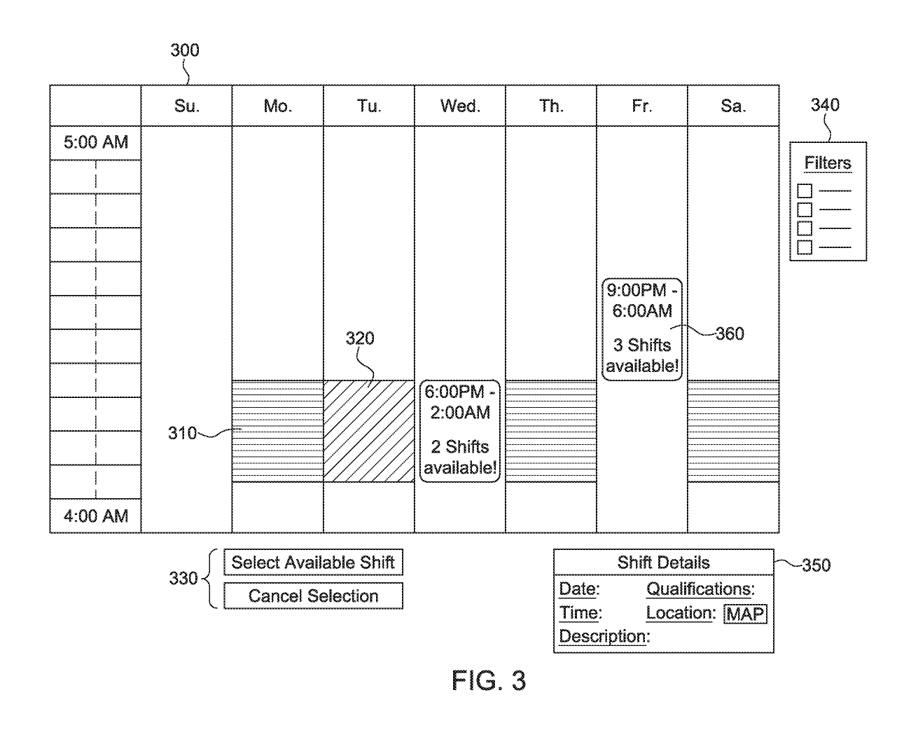

FIG. 3 shows an example user interface including an interactive shifter calendar 300. When a shifter 130 accesses the shift worker platform 400, the shifter calendar 300 may be one of a plurality of user interface views available to the shifter 130, e.g. on a display of a computing device associated with the shifter 130. The shifter calendar 300 allows the shifter 130 to easily see suitable shifts to work as well as schedule gaps where no suitable shifts are available, in which case the shifter 130 might cast a wider net by working outside her typical geographic area or below her typical minimum pay. Similar to the job provider client calendar 200 shown in FIG. 2, shifter calendar 300 shown in FIG. 3 may be a weekly calendar arranged with columns representing the days of a week and rows representing time slots, e.g. hours. In the example shown in FIG. 3, the time slots run from 5:00 AM through 4:00 AM (24 hours) and the days run from Sunday through Saturday (7 days), but the job provider client calendar 300 may be customizable to limit the view to the hours of interest of the particular shifter 130. The shifter calendar 300 may include one or more filled shifts 310, one or more schedule gaps 320, a plurality of buttons 330, a filters panel 340, a shift details panel 350, and one or more available shifts 360.

The filled shifts 310 of the shifter calendar 300 represent working hours of the shifter 130 during which the shifter 130 is already scheduled to work a shift. In the example shown in FIG. 3, the filled shifts 310 are simply grayed out, but the filled shifts 310 may further include a display of information about the shift and/or interactive buttons to contact the job provider 210, for example, in the event that the shifter 130 cannot fill the shift and must withdraw from the shift (potentially allowing a waitlisted shifter 130 to take the shift as described below).

The schedule gap 320 represents a time slot within the working hours of the shifter 130 during which the shifter 130 is not scheduled to fill a shift and no suitable available shift 360 has been found for the shifter 130. In the example of FIG. 3, the shifter 130 has limited her working hours to evening shifts on Monday, Tuesday, Wednesday, Thursday, and Saturday and a Friday daytime shift. The shifter 130 may set her working hours by adjusting settings of her user profile, for example. No available shifts 360 are shown for the times outside the working hours of the shifter 130, and schedule gaps 320 are only shown within the working hours of the shifter 130. In this way, the shifter 130 may limit her view to only those times and days when she is interested in working. In some cases, the shifter 130 may already have a part-time job with a business that is not a job provider client 120 of the CEE 110 and does not use the shift worker platform 400. The working hours of the shifter 130 may represent those times and days when the shifter 130 does not already have work at such an outside job.

The available shifts 360 (shown in the form of rounded rectangular “bubbles” on Wednesday and Friday) may represent those available shifts 260 created by job provider clients 120 (see FIG. 2) for which the shifter 130 is particularly suited. For example, based on the user profile of the shifter 130, the shift worker platform 400 may show a selection of available shifts 260 that match the qualifications, geographic location, and preferences (e.g. minimum pay) of the shifter 130. In the example of FIG. 3, the shifter calendar 300 displays two available shifts on Wednesday and three available shifts on Friday. The shifter 130 may interact with (click, tap, etc.) the bubbles to cycle through the available shifts 360 to learn the details of each. For example, the shift details panel 350 may display the details of a given available shift 360 as the shifter 130 cycles through the available shifts 360 or may display a comparison view showing the details of all of the available shifts 360 of a particular time slot in the shifter calendar 300. The shift details panel 350 may show information similar to the shift details panel 250 of the job provider client calendar 200, e.g. public parameters and not private parameters that the job provider 120 chooses to hide from the shifters 130. The shift details 350 may provide access to a map view in which the geographic locations of available shifts 360 may be more easily compared.

The filters panel 340 may function to limit the number of displayed available shifts 360, for example, if there are too many to easily cycle through or if the shifter 130 would like to further restrict her preferences for a particular time slot or for a particular week. Filters may include geographic filters, e.g. within 5 miles from home or within 5 miles from designated location (if the shifter 130 has a short time between shifts, for example), job type/description filters, e.g. bartender only (even though the shifter 130 may be qualified as a bartender and as a server), time filters, e.g. shifts ending early relative to a designated calendar slot (some available shifts 360 in the 6:00 AM to 2:00 AM slot may actually end at 1:30 AM, for example), etc. In this way, the shifter calendar 300 may allow a shifter 130 to temporarily adjust which available shifts 360 are visible without needing to adjust her user profile.

As noted above, the schedule gap 320 represents a time slot within the working hours of the shifter 130 during which the shifter 130 is not scheduled to fill a shift and no suitable available shift 360 has been found for the shifter 130. In the example shown in FIG. 3, there is a schedule gap 320 Tuesday evening. The shifter calendar 300 may highlight the schedule gap 320 or otherwise make it conspicuous to the shifter 130. Noticing the schedule gap 320, the shifter 130 may select the schedule gap 320 (e.g. using a mouse, keyboard, touch panel, or other input device) and conduct a search for additional available shifts that have not been displayed to the shifter 130 as available shifts 360. Such shifts may exist because the shifter calendar 300 may initially only display available shifts 360 that match the qualifications and preferences of the shifter 130 as described above. In order to fill a schedule gap 320, the shifter 130 may be willing to commute farther or accept lower pay than what is set in her user profile. When conducting a search based on a schedule gap 320, the shifter 130 may relax such preferences, e.g. using a separate user interface view in the form of a pop-up window or search panel linked to the selected schedule gap 320.

When the shifter 130 would like to work one of the available shifts 130, the shifter 130 may select the available shift 130 using, for example, a “select available shift” button of the plurality of buttons 330. In the case where a shifter 130 conducted a search outside of the displayed available shifts 130 in order to fill a schedule gap 320, the shifter 130 may similarly select a shift using the “select available shift” button or a button associated with the user interface view of the search. In either case, the time slot associated with the selected shift may be replaced by a grayed out region representing a filled shift 310 (instead of a schedule gap 320 or a bubble representing available shifts 360). Of course, as in the case of FIG. 2, the particular visual appearances of the elements of the shifter calendar 300 are only examples and many other visual appearances are possible. As described in more detail below, selection of a shift by a shifter 130 generates data that is used by the shift worker platform 400 to assist the shifter 130 in applying for the shift and to assist the job provider client 120 in filling the shift. If the shifter 130 wishes to undo this process, e.g. to remove herself as a candidate, she may use a “cancel selection” button of the plurality of buttons 330, causing the filled shift 310 to return to its previous status (e.g. schedule gap 320 or available shifts 360).

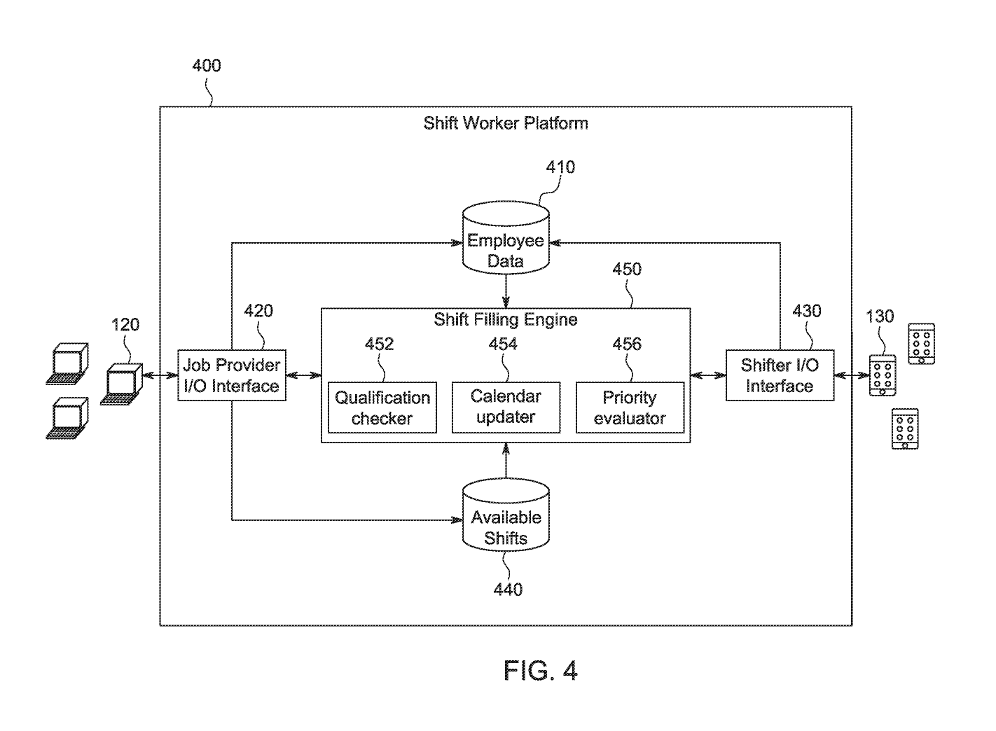

FIG. 4 shows an example shift worker platform 400 according to an embodiment of the present disclosure. The shift worker platform 400 supports the transitioning of siloed workers 140 from the restrictive silos 150 of job provider clients 120 to becoming free shifters 130 (see FIG. 1). The shift worker platform 400 further supports interactive calendar access by job provider clients 120 and shifters 130, e.g. access to the calendars 200, 300 described above (see FIGS. 2 and 3). In this regard, the shift worker platform 400 receives data of the available shifts 260 of job provider clients 130, establishes one or more matches with shifters 130, updates the shifter calendars 300 of the matching shifters 130, receives data of the shift selections of shifters 130, and fills the available shifts 260 with appropriate shifters 130. The shift worker platform 400 may include an employee data storage 410, a job provider I/O interface 420, a shifter I/O interface 430, an available shifts storage 440, and a shift filling engine 450.

The employee data storage 410 stores employee data of the employees of the CEE 110. The employee data for each employee may include identifying information such as an employee ID number, login/security information such as username, password, etc., personal information such as name, address, date of birth, social security number, photo, etc., contact information such as email address, phone number, emergency contact, etc., payment-related information such as bank account number, bank routing number, etc., work-related information such as prior employment outcome, driver's license status, references, work experience, qualifications, etc. and work-related preferences such as minimum salary requirements, geographic range, preferred/available days and hours, preferred/available start date, preferred job type/description, etc. As noted above, the employees of the CEE 160 may include both siloed workers 140 who are associated with job provider clients 120 as well as shifters 130 who are not associated with any of the job provider clients 120. In this case, the employee data storage 410 may further store, for each employee, a flag or other marker indicating whether the employee is a shifter 130. Alternatively, the employee data storage 410 may store shifters 130 separately from non-shifter employees, e.g. in a separate sub-storage.

The job provider I/O interface 420 receives commands and/or data from computing devices associated with job provider clients 120 for processing by the shift worker platform 400 and outputs one or more of the various outputs of the shift worker platform 400 for use by job provider clients 120. The job provider I/O interface 420 may, for example, receive a shifter designation command designating an employee from among the plurality of employees of the CEE 110 to become one of the plurality of shifters 130. In response to receiving the shifter designation command, the I/O interface 420 may update the employee data in the employee data storage 410 to flag the employee as a shifter 130 or to move the employee data of that employee to a sub-storage devoted to shifters 130. In this way, the shift worker platform 400 may support the transitioning of a siloed worker 140 to a shifter 130.

The job provider I/O interface 420 may further receive various data generated by user interaction with a job provider client user interface, e.g. the job provider client calendar 200 shown in FIG. 2. For example, a job provider client 120 with an available work shift may use the shift worker platform 400 to fill the shift. To this end, the job provider client 120 may create an available shift 260 as described above using the job provider client calendar 200. The job provider I/O interface 420 may receive available shift data generated by the user interaction of the job provider client 120 with the job provider client calendar 200, the available shift data representing the available shift 260 of the job provider client 120. The job provider 110 interface 420 may store the available shift data in the available shifts storage 440.

The outputting of data by the job provider I/O interface 420 may include storing of the output data of the shift worker platform 400 in association with a particular job provider client 120 for access (e.g. cloud access) by the job provider client 120 via a mobile, Web, or other application. In addition to data associated with the process of filling the available shift 260 (described in more detail below), the data output by the job provider I/O interface 420 may further include other types of output data. For example, the output data may include user profile data of the job provider client 120 requested by the job provider client 120. As another example, the output data may include data associated with displaying the various user interfaces including the job provider client calendar 200 and/or prompting the job provider client 120 for user input.

The shifter I/O interface 430 receives commands and/or data from computing devices associated with shifters 130 for processing by the shift worker platform 400 and outputs one or more of the various outputs of the shift worker platform 400 for use by shifters 130. The shifter I/O interface 430 may, for example, receive user profile data of a shifter 130 as the shifter 130 creates or modifies her user profile via a user interface of the shift worker platform 400. The shifter I/O interface 430 may store the user profile data in the employee data storage 410 in association with the particular shifter 130.

The shifter I/O interface 430 may further receive shift selection data generated by user interaction of the shifter 130 with the shifter calendar 300, the shift selection data including a selection of an available work shift by the shifter 130. For example, when viewing her shifter calendar 300, the shifter 130 may notice an available shift 360 that she is interested in filling or may find an available shift when conducting a search to fill a schedule gap 320 as described above in relation to FIG. 3. The user interaction of selecting the shift may generate shift selection data which may then be received by the shifter I/O interface 430 in response to the selection. The shift selection data may include, for example, identifying information associating it with the particular shift that was selected, as well as identifying information associating it with the shifter 130 who made the selection (e.g. the shifter 130 whose shifter calendar 300 was interacted with to generate the shift selection data).

The outputting of data by the shifter I/O interface 430 may include storing of the output data of the shift worker platform 400 in association with a particular shifter 130 for access (e.g. cloud access) by the shifter 130 via a mobile, Web, or other application. In addition to data associated with the process of filling the available shift 260 (described in more detail below), the data output by the shifter I/O interface 430 may further include other types of output data. For example, the output data may include user profile data of the shifter 130 requested by the shifter 130. As another example, the output data may include data associated with displaying the various user interfaces including the shifter calendar 300 and/or prompting the shifter 130 for user input.

The available shifts storage 440 stores available shift data representing the available shifts 260 created by the plurality of job provider clients 120. For example, upon the creation of an available shift 260, the job provider 110 interface 420 may store available shift data in the available shifts storage 440 including the date, time, location, qualifications, description, and any other public or private shift details of the available shift 260. The available shift 260 may be stored in association with the job provider client 120 who created it, e.g. the job provider client 120 whose job provider client calendar 120 was interacted with to generate the available shift 260. Later on, when the available shift 260 is deleted by the job provider client 120 or filled by a shifter 130, the job provider 110 interface 420 may erase the corresponding available shift data from the available shifts storage 440. In this way, the available shifts storage 440 may act as a temporary store of currently available shifts. Alternatively, rather than erase the available shift data, the job provider 110 interface 420 may mark the available shift data as corresponding to a deleted or filled shift. In this way, the available shifts storage 440 may further act as an archive of past shifts.

The shift filling engine 450 performs various operations and calculations associated with filling an available shift 260 of a job provider client 120. Conversely, the shift filling engine 450 performs various operations and calculations associated with finding available shifts 360 for a shifter 130 to fill. The shift filling engine 450 includes a qualification checker 452, a calendar updater 454, and a priority evaluator 456.

As an example, a job provider client 120 may wish to post an available shift 260 and may therefore interact with the job provider client calendar 200 to generate available shift data as described above. Upon the available shift data being stored in the available shifts storage 440 by the job provider I/O interface 420, the shift filling engine 450 may retrieve the available shift data from the available shifts storage 440. For example, the shift filing engine 450 may regularly access the available shifts storage 440 for updated available shift data or may do so in response to a command issued from the job provider I/O interface 420. Upon retrieving the available shift data from the available shifts storage 440, the shift filling engine 450 may compare the available shift data to the employee data stored in the employee data storage 410 to find potential candidates for the shift. For example, the qualification checker 452 of the shift filling engine 450 may search the employee data storage 410 for all shifters 130 (e.g. employees flagged or stored as shifters 130 rather than siloed employees 140) for whom certain qualifications are met, such as i) the shifter meets the minimum qualifications included in the available shift data (e.g. experience, certifications, etc.) and ii) the available shift 260 represented by the available shift data meets the qualifications/preferences of the employee (e.g. geographic location, minimum pay, job description, etc.). More generally, the qualification checker 452 may check, for each of the plurality of shifters 130, whether the shifter 130 meets a qualification associated with the available shift data and/or whether the available work shift meets a qualification associated with the shifter 130. In this way, the qualification checker 452 may establish one or more matches between the available shift data of the available shift 260 and the plurality of shifters 130 using the shift worker platform 400.

Having found one or more matching shifters 130 for the available shift 260, the shift filling engine 450 may post the available shift 260 for consideration by those matching shifters 130. To this end, the calendar updater 454 of the shift filling engine 450 may update the shifter calendars 300 of each of the matching shifters 130 to include a visual representation of the available shift 260. The visual representation may, for example, be in the form of available shifts 360 as described in relation to FIG. 3. Because the shift worker platform 400 supports a plurality of shifters 130, similar available shifts 360 may appear on the shifter calendars 300 of ten or twenty (or any number of) shifters 130. At the same time, because the shift worker platform 400 supports a plurality of job provider clients 120, each of these shifters 130 may simultaneously be confronted with multiple available shifts 360 for the same time slots in their shifter calendars 300 (e.g. “3 shifts available!” in FIG. 3). Thus, out of the matching shifters 130 who are notified of the available shift 260 created by the job provider client 120 of this example, some subset of those matching shifters 130 might select the shift. In some cases, shifters 130 who were not a match may also select the same shift, as they might have found the shift by conducting an expansive search to fill a schedule gap 320 as described above. In this way, the shifter I/O interface 430 may receive shift selection data generated by user interaction with the shifter calendar 300 of a first shifter 130 of the plurality of shifters 130 for whom a match was established and receive shift selection data generated by user interaction with the shifter calendar 300 of a second shifter 130 of the plurality of shifters 130 for whom a match was established. The shift selection data of the first shifter 130 may include a selection of an available work shift by the first shifter 130, while the shift selection data of the second shifter 130 may include a selection of the same available work shift by the second shifter 130.

In response to the receipt of shift selection data by the shifter I/O interface 430, the shift filling engine 450 may assist the job provider client 120 in choosing a shifter 130 to fill the shift by comparing the shift selection data received by the shifter I/O interface 430 to the available shift data stored in the available shifts storage 440. Matches between the incoming shift selection data and the available shift data stored in the available shifts storage 440 may produce one or more candidates for the shift. To this end, as noted above, the shift selection data may include identifying information associating it with the particular shift that was selected, as well as identifying information associating it with the shifter 130 who made the selection (e.g. the shifter 130 whose shifter calendar 300 was interacted with to generate the shift selection data). Since there may be two or more shifters 130 who selected the shift, the shift worker platform 400 may evaluate priority between the candidates as follows.

The priority evaluator 456 of the shift filling engine 450 may compare the employee data of the plurality of shifters 130 who selected the available shift 260 by referring to the employee data storage 410. The comparison may be made with reference to parameters of the available shift data, such as private parameters set by the job provider client 120. As a specific example, the job provider client 120 may have required only two years of experience for the shift but expressed a preference (privately or publicly) for candidates with additional years of experience. The job provider client 120 may have further requested to only see the five candidates having the most experience (e.g. by adjusting private parameters of the shift details 350). Based on these preferences of the job provider client 120, the priority evaluator 456 may choose the five shifters 130 having the most experience from among the plurality of shifters 130 who selected the available shift 260. In other cases, the job provider client 120 may prioritize candidates with short commute times (to avoid tardiness), specific work or education backgrounds, the availability of the shifter 130 to perform the shift with respect to the shifter calendar 300 of the shifter 130, a rating/score of the shifter 130 with the shift worker platform 400, or any other quality or measure. In this way, the priority evaluator 456 may evaluate a priority between the candidates (e.g. between a first shifter 130 and a second shifter 130). The priority evaluator 456 may prioritize the candidates by omitting some (e.g. top five) or simply by ranking them (e.g. good/better/best) for easier review by the job provider 120.

Having finalized a list of one or more shifters 130 interested in filling the available shift 260, the shift filling engine 450 may provide the information to the job provider 420 for consideration. To this end, the calendar updater 454 of the shift filling engine 450 may update the job provider calendar 200 of the job provider 120 to include a visual representation of the selection of the available shift 260 by one or more shifters 130, e.g. those shifters 130 who were prioritized by the priority evaluator 456. The visual representation may, for example, be in the form of a notification on the job provider calendar 200, e.g. on the available shift 260. Interacting with the notification or the available shift 260 may cause a user interface showing the candidate shifter(s) 130 to be displayed. For example, in the case of a first shifter 130 and a second shifter 130 for whom priority has been evaluated by the priority evaluator 456, the calendar updater 454 may update the job provider client calendar 200 to include a visual representation of the selections by the first and second shifters 130 and an indication of the priority between the first and second shifters 130.

The shift worker platform 400 may have additional functionality to allow the job provider 120 to fill the available shift 260 with one of the candidate shifter(s) 130. For example, the job provider 120 may select a candidate shifter 130 to fill the shift by interaction with additional onscreen buttons, e.g. on the job provider client calendar 200. The job provider I/O interface 420 may receive shifter selection data generated by the user interaction of the job provider 120 with the job provider calendar 200 or other interface, the shifter selection data including the selection of a shifter to fill the available work shift. Upon receiving the shifter selection data, the shift worker platform 400 may inform the selected shifter 130, for example, by updating her shifter calendar 300 using the calendar updater 454 to include a visual representation of the selection of the shifter 130 to fill the work shift. Thereafter, the shifter 130 may confirm that she will fill the shift by interaction with a user interface of the shifter 130, e.g. the shifter calendar 300. The shifter I/O interface 430 may receive confirmation data generated by the user interaction of the shifter 130 with the shifter calendar 300 or other interface, the confirmation data including the confirmation that the shifter 130 will fill the work shift. Upon receiving the confirmation data, the shift worker platform 400 may inform the job provider client 120, for example, by updating the job provider calendar 200 of the job provider client 120 using the calendar updater 454 to include a visual representation of the confirmation.

When the job provider 120 selects a candidate shifter 130 to fill a shift, e.g. by interaction with the job provider client calendar 200, the job provider 120 may select additional candidate shifters 130 to be waitlisted or additional candidate shifters 130 may be selected to be waitlisted by default (e.g. the next highest priority shifters 130 as previously determined by the priority evaluator 456). The shifter selection data received by the job provider I/O interface 420 may therefore include a selection of a first shifter to fill the available work shift and a selection of a second shifter to be waitlisted. Upon receiving the shifter selection data, the shift worker platform 400 may inform the selected shifters 130, for example, by updating the shifter calendar 300 of the first shifter 130 using the calendar updater 454 to include a visual representation of the selection of the first shifter 130 to fill the work shift and updating the shifter calendar 300 of the second shifter 130 using the calendar updater 454 to include a visual representation of the selection of the first shifter 130 to be waitlisted.

By supporting waitlist functionality, the shift worker platform 400 helps a job provider client 120 avoid a situation where a shift remains unfilled even though there may have been additional shifters 130 interested. From the perspective of the shifters 130, the waitlist functionality increases the likelihood of working a shift. If a shifter 130 who was selected to fill a shift decides not to fill the shift and does not confirm the shift, the shifter 130 may actively withdraw from consideration using an interface such as the shifter calendar 300 or may be automatically withdrawn from consideration after a set period of time for confirmation. Thus, the shifter I/O interface 430 may receive shifter withdrawal data generated by user interaction of a first shifter 130 with the shifter calendar 300 or other interface, the shifter withdrawal data including a withdrawal from consideration for the work shift by the first shifter 130. Upon receiving the shifter withdrawal data, the shift worker platform 400 may inform a second shifter 130 who is next on the waitlist, for example, by updating the shifter calendar 300 of the second shifter 130 using the calendar updater 454 to include a visual representation of the automatic selection of the second shifter 130 to fill the work shift.

Alternatively, the selection of the second shifter 130 may not be automatic and may require further approval from the job provider client 120. This may depend, for example, on the preferences of each job provider client 120 or by a choice made by the job provider client 120 when selecting the additional candidates for the waitlist. Upon receiving the shifter withdrawal data, the shift worker platform 400 may inform the job provider client 120 of the withdrawal, for example, by updating the job provider client calendar 200 of the job provider client 120 using the calendar updater 454 to include a visual representation of the withdrawal, which may include an indication of who is next on the waitlist. The job provider client 120 may then make a revised selection indicating the next (or a different) shifter 130 as the selected shifter 130 to fill the shift and/or new waitlist selections. Thus, the job provider client I/O interface 420 may receive revised shifter selection data generated by user interaction of a job provider client 120 with the job provider client calendar 200 or other interface, the revised shifter selection data including a selection of a second shifter to fill the work shift. Upon receiving the revised shifter selection data, the shift worker platform 400 may inform the newly selected shifter 130, for example, by updating the shifter calendar 300 of the second shifter 130 using the calendar updater 454 to include a visual representation of the selection of the second shifter 130 to fill the available work shift.

Upon the confirmation that a shift will be filled, the shifter I/O interface 430 may update the available shifts storage 440, for example, to remove or archive the available shift 260 as described above. In some cases, final confirmation by the shifter 130 may be omitted and the selection by the job provider 120 of the shifter 130 may constitute the last substantial step of filling a shift. In this case, the job provider I/O interface 420 rather than the shifter I/O interface 430 may update the available shifts storage 440. In some cases, instead of simply removing or archiving the available shift 260, the job provider I/O interface 420 may mark the available shift 260 as filled and postpone removing/archiving the available shift 260 until after the time of the actual shift. This way, if it turns out that the confirmed shifter 130 cannot work the shift, the shift may become available again, e.g. to be filled by the candidate shifter 130 with next highest priority on a waitlist, for example.

As noted above, a user interface such as the shifter calendar 300 may support functionality for searching for additional shifts to fill a schedule gap 320. To this end, the shifter I/O interface 430 may receive a search request from a shifter 130, the search request indicating a temporary relaxing of the qualifications associated with the shifter 130 for use by the qualification checker 452 in establishing matches. As also noted above, a user interface such as the shifter calendar 300 may include filters 340. The shifter I/O interface 430 may receive a filter request from a shifter 130, the filter request indicating a temporary tightening of the qualifications associated with the shifter 130 for use by the qualification checker 452 in establishing matches.

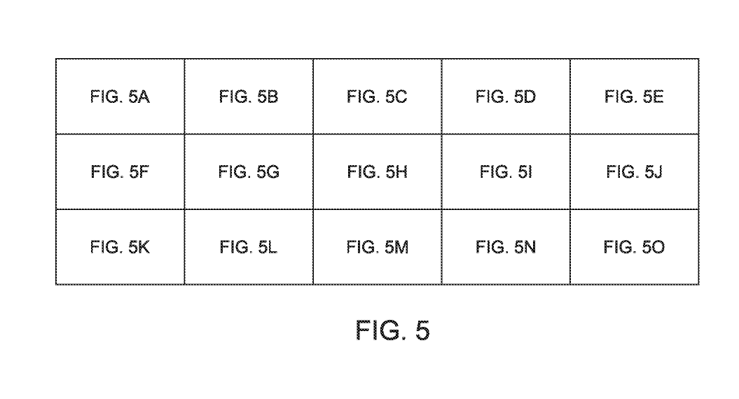

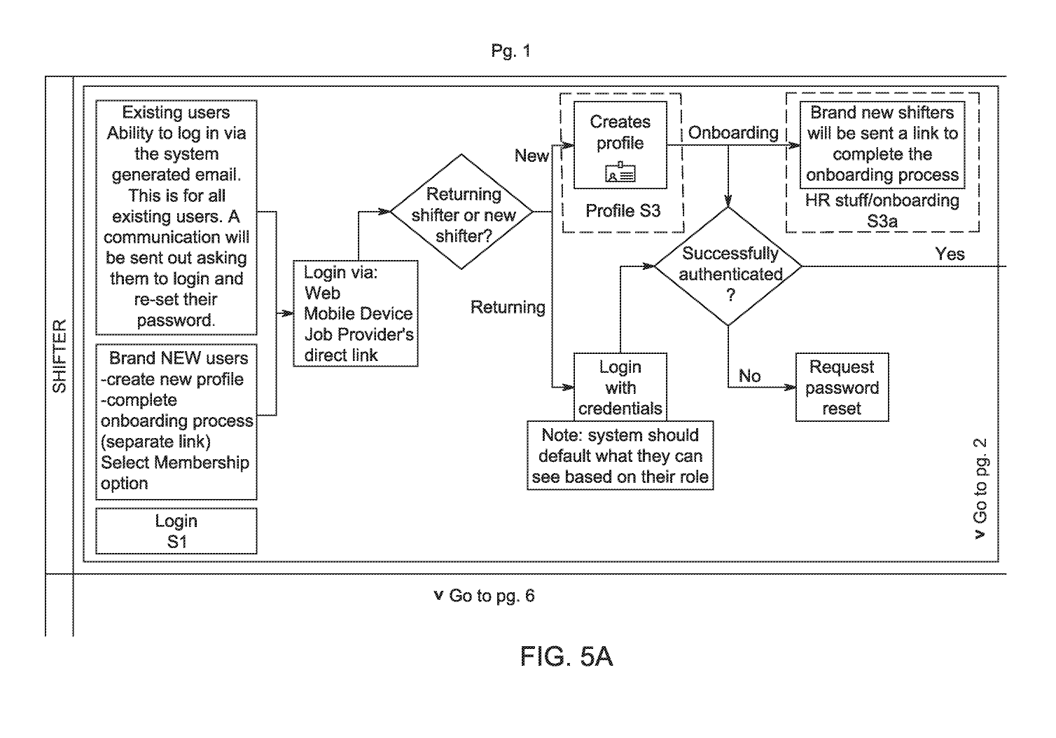

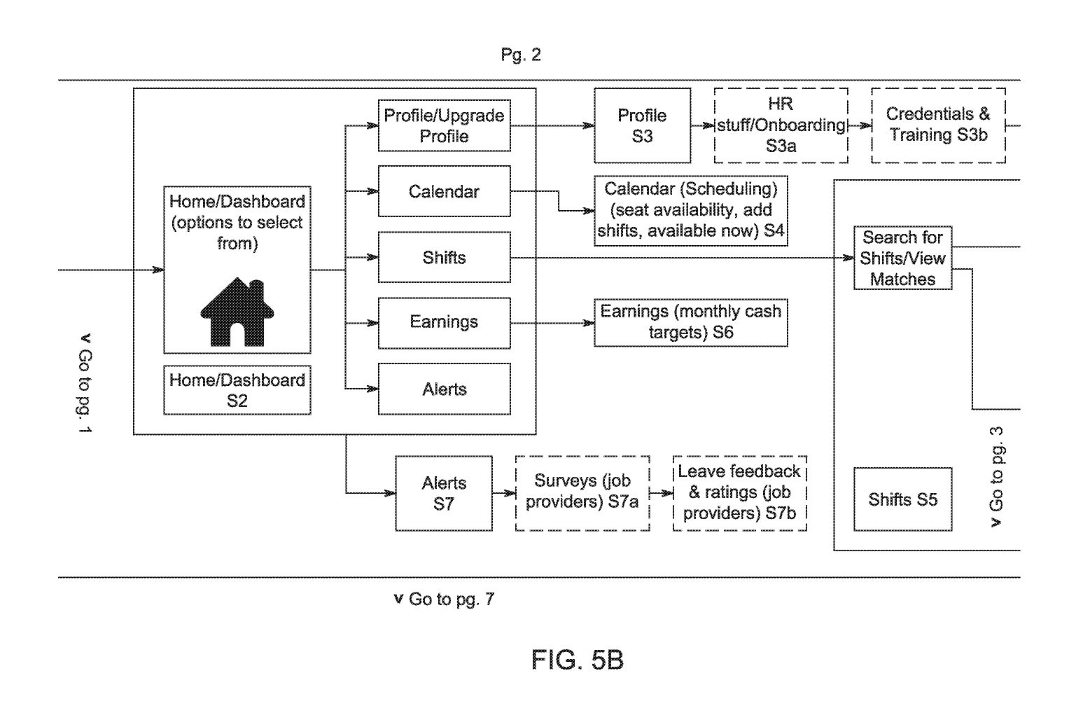

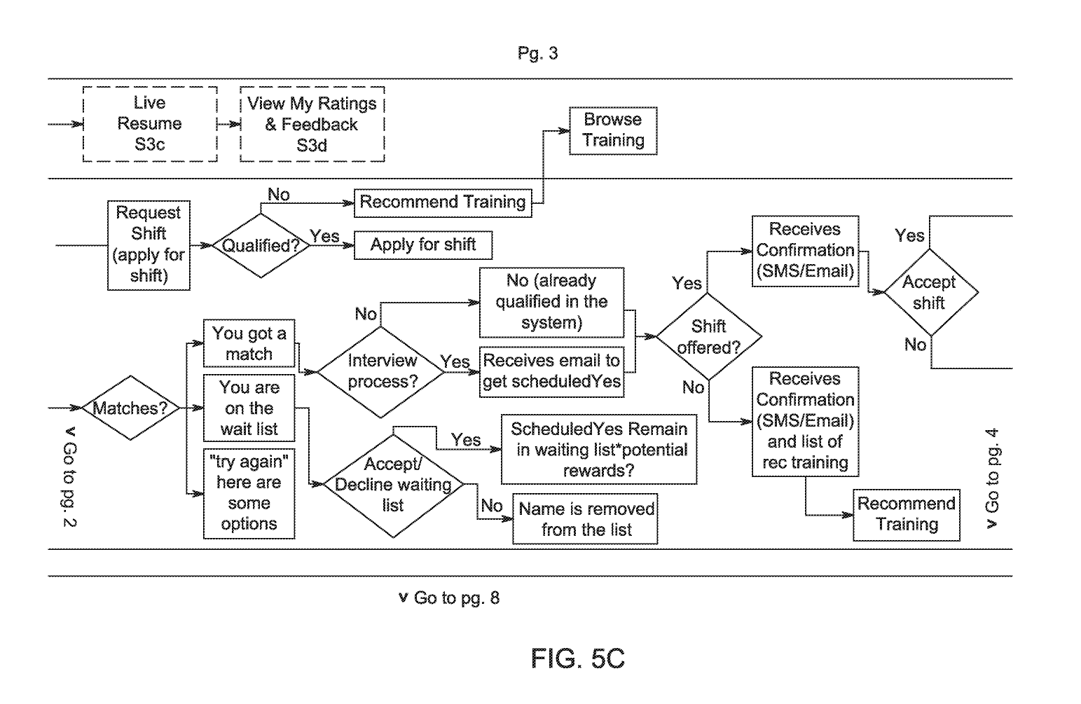

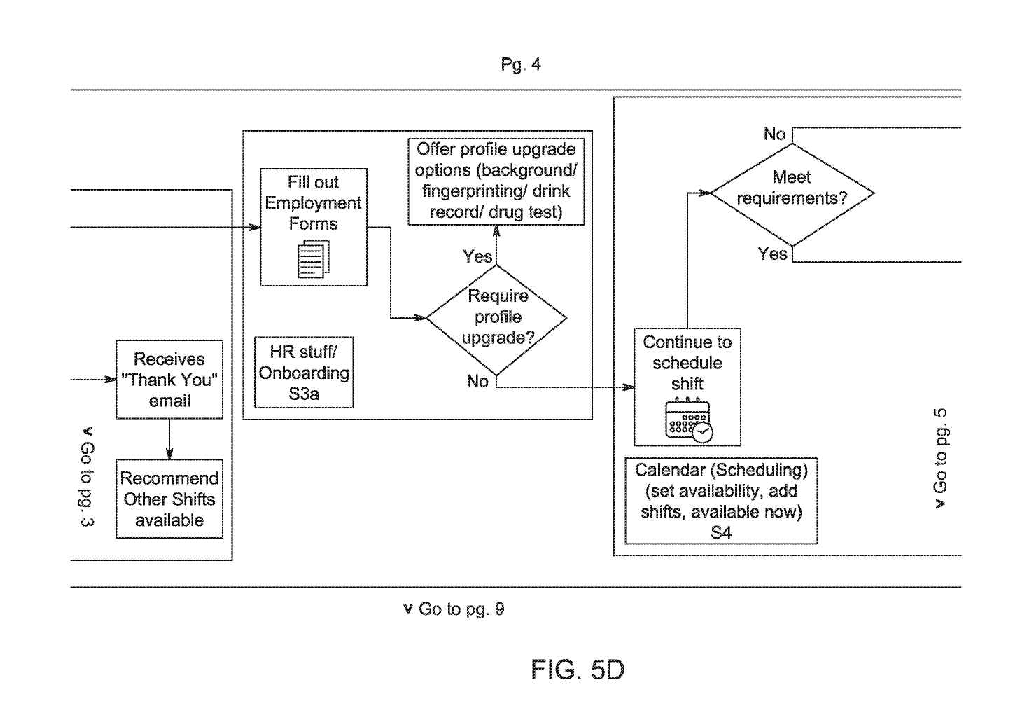

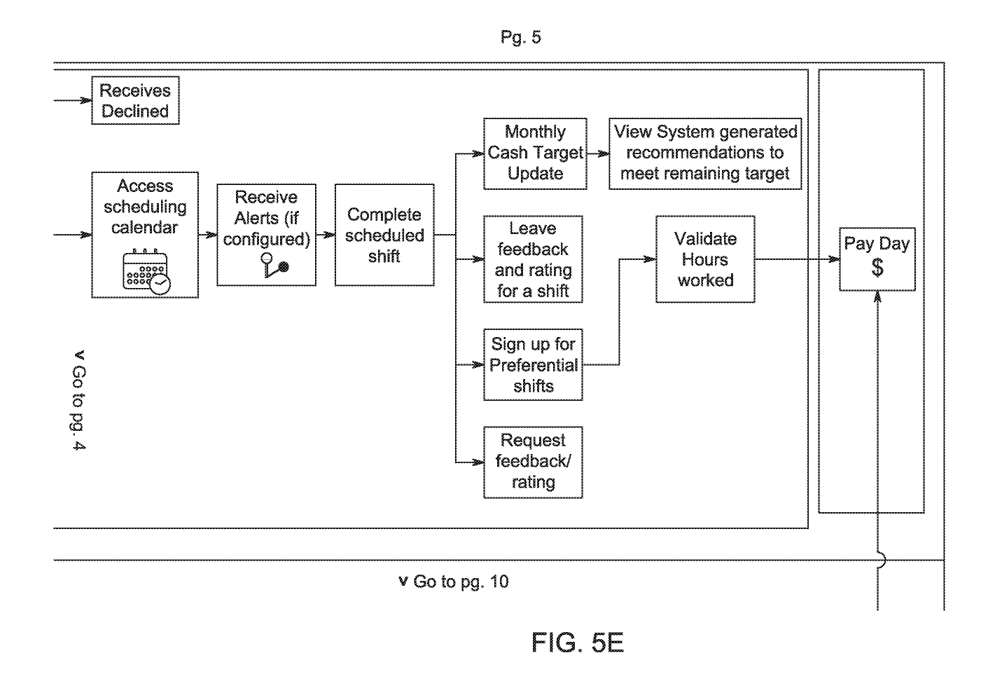

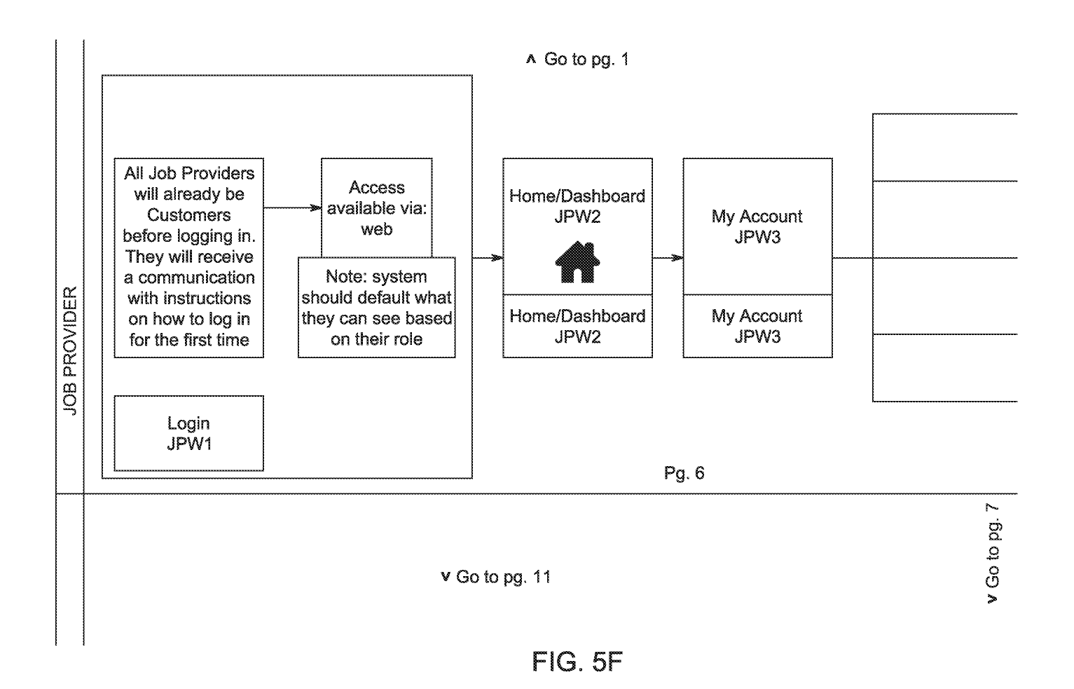

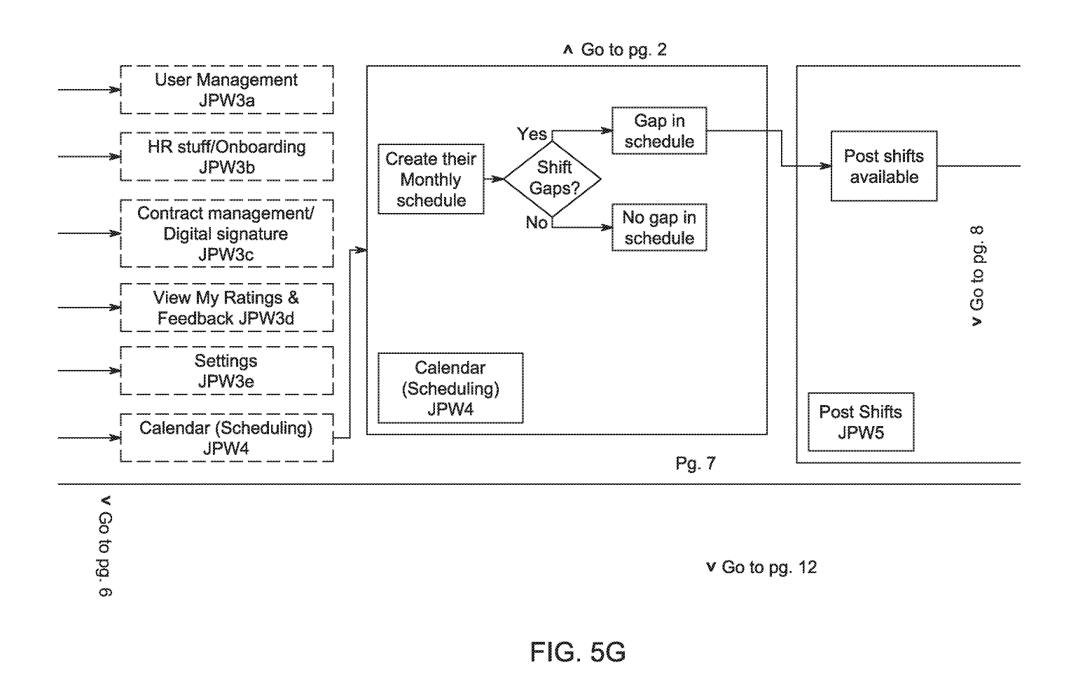

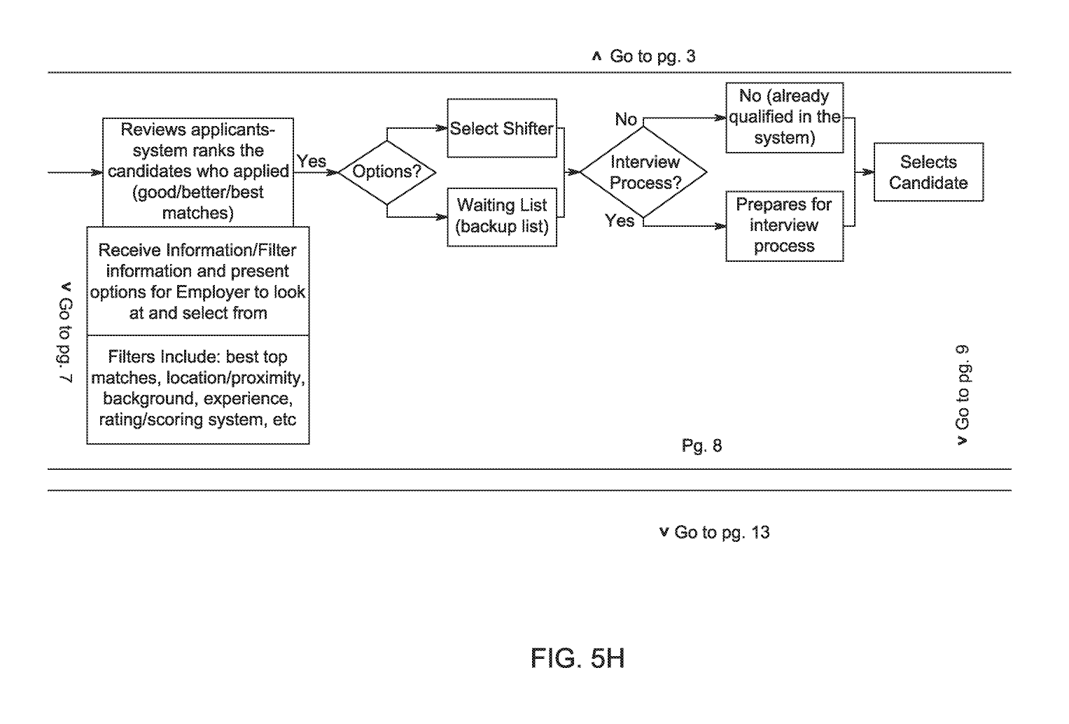

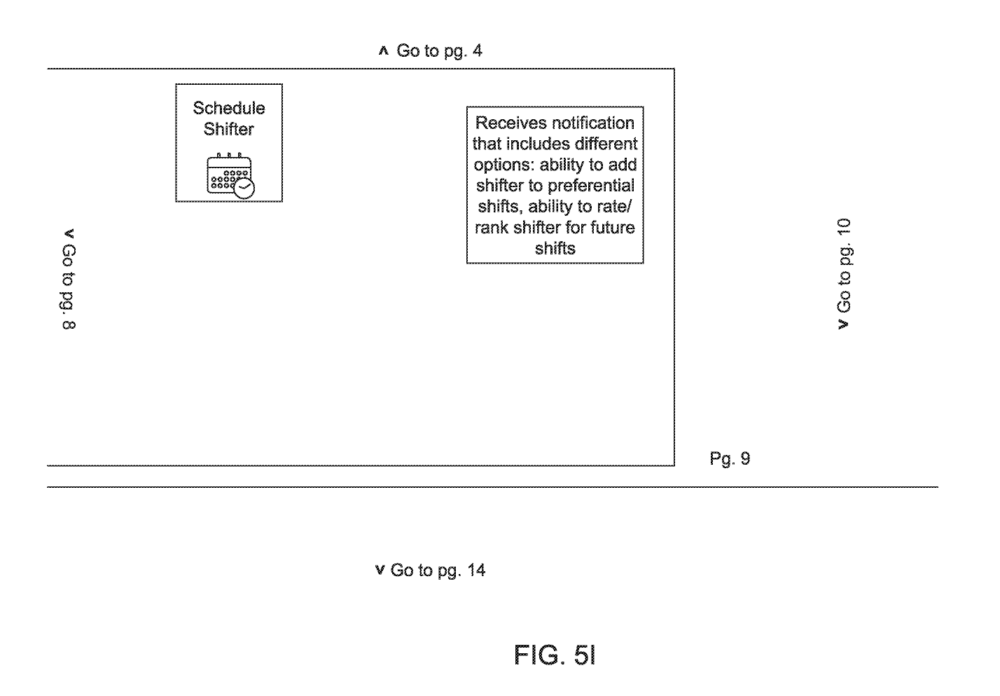

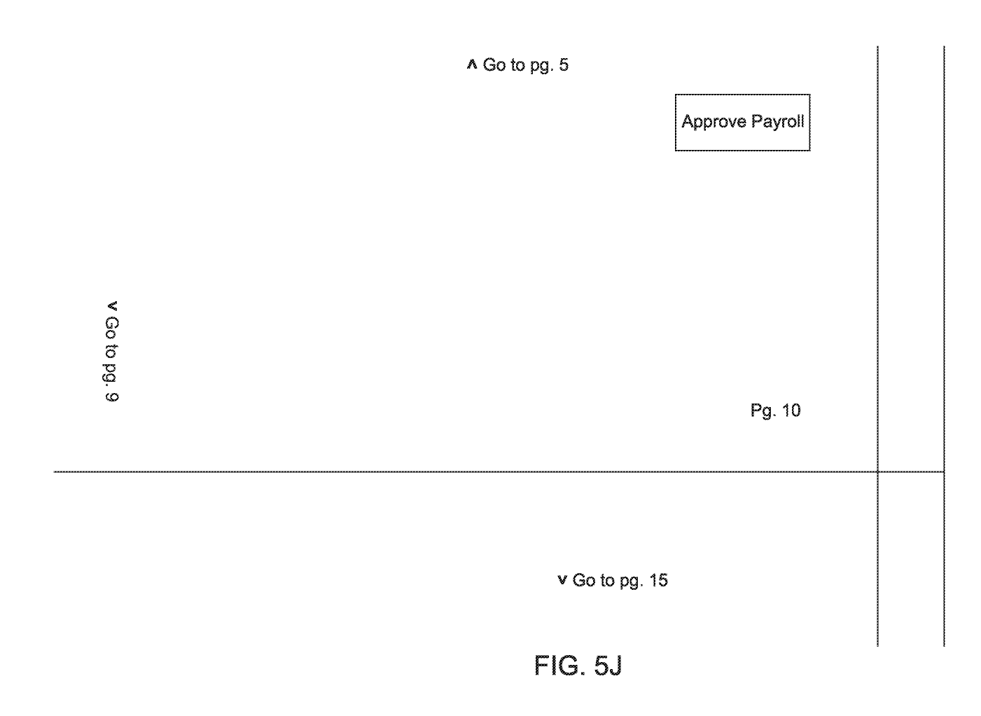

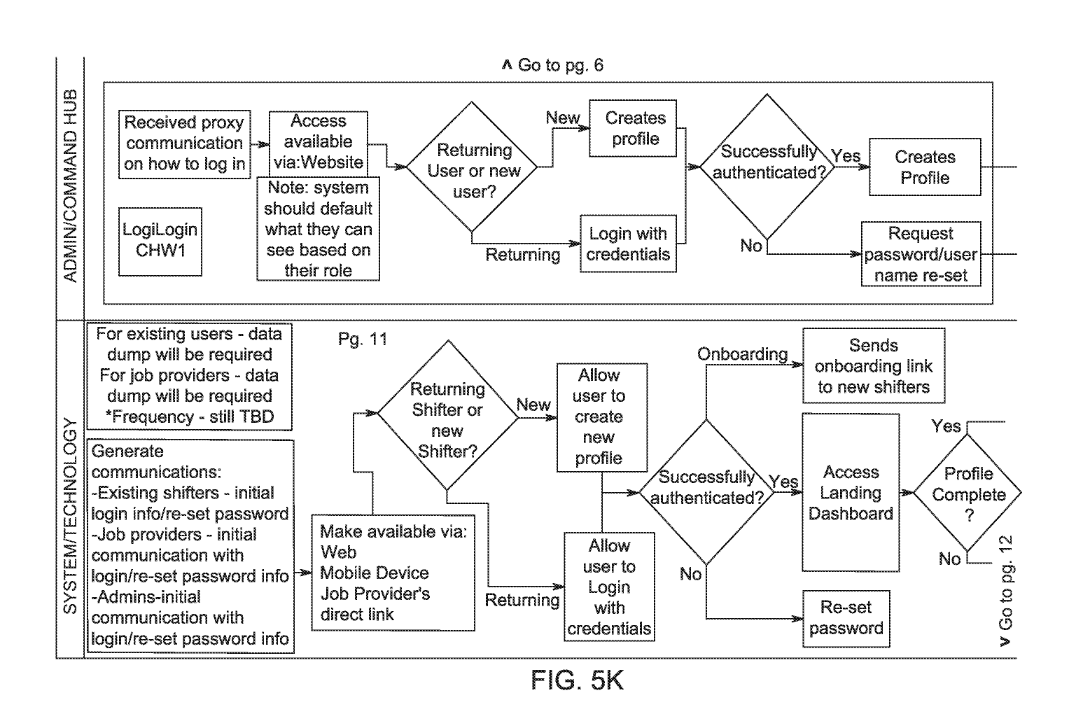

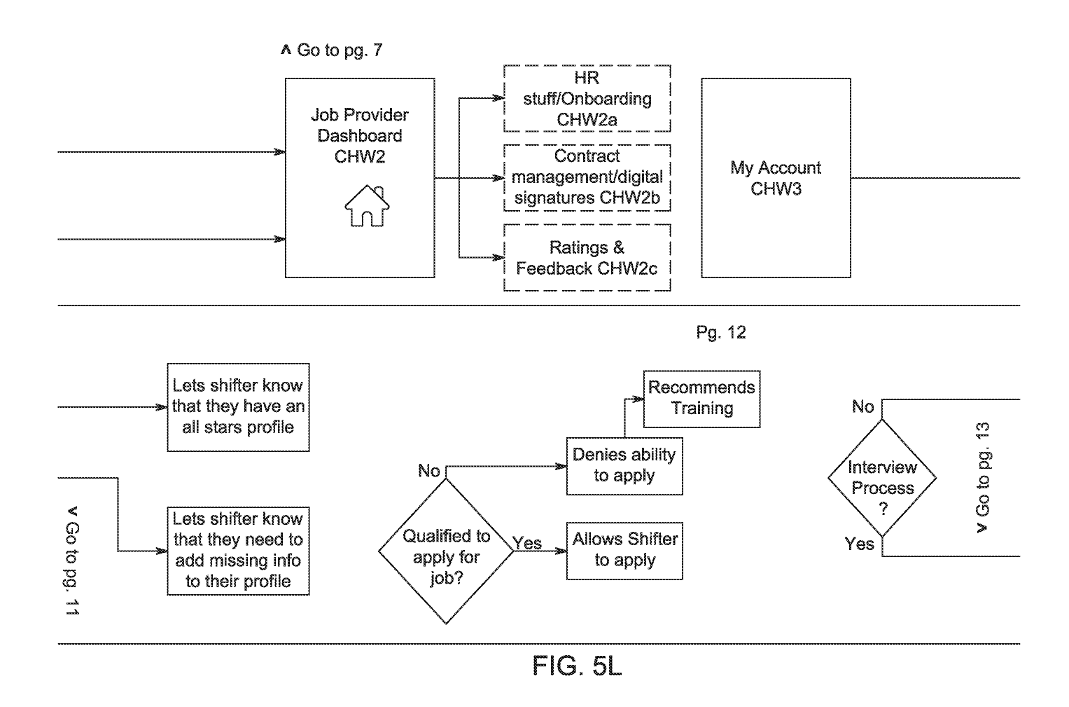

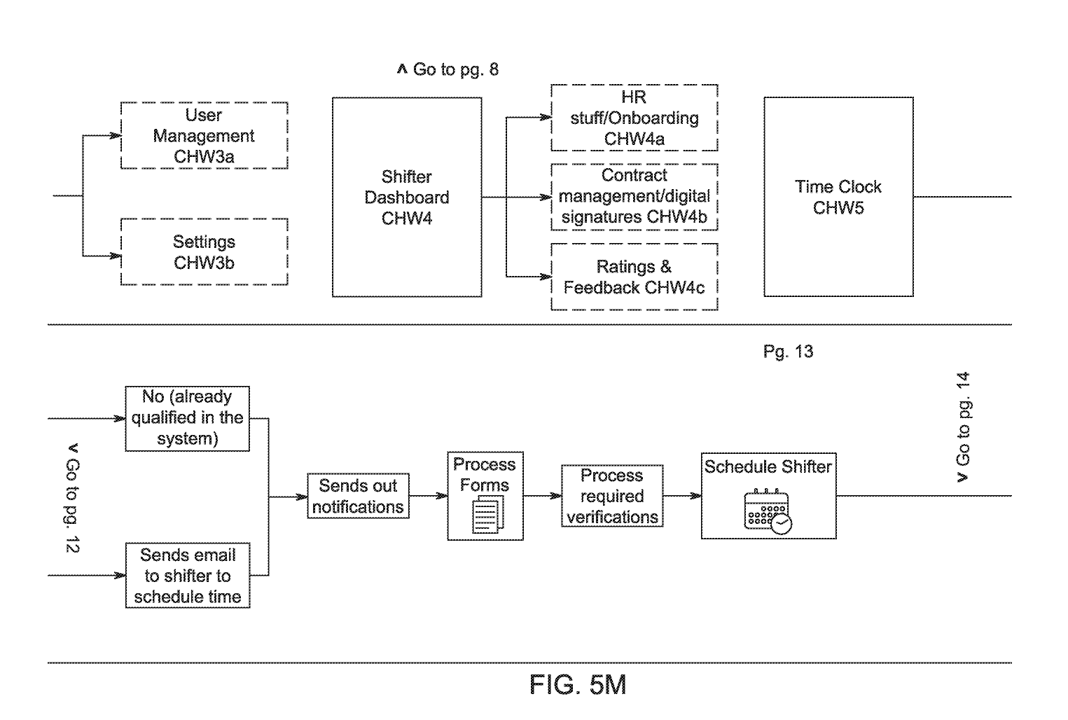

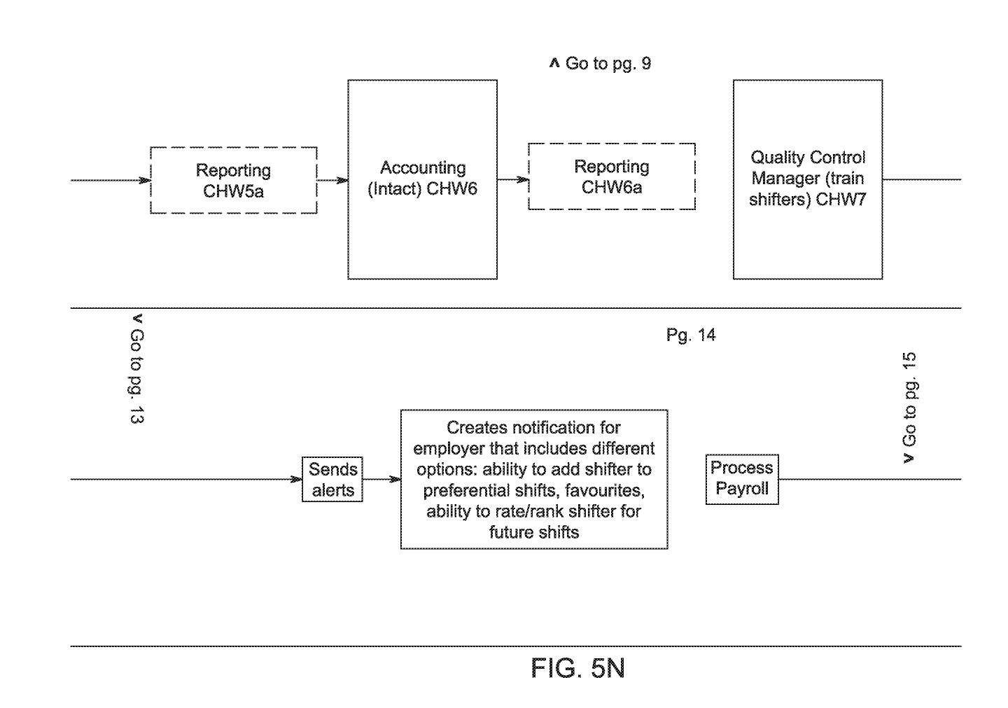

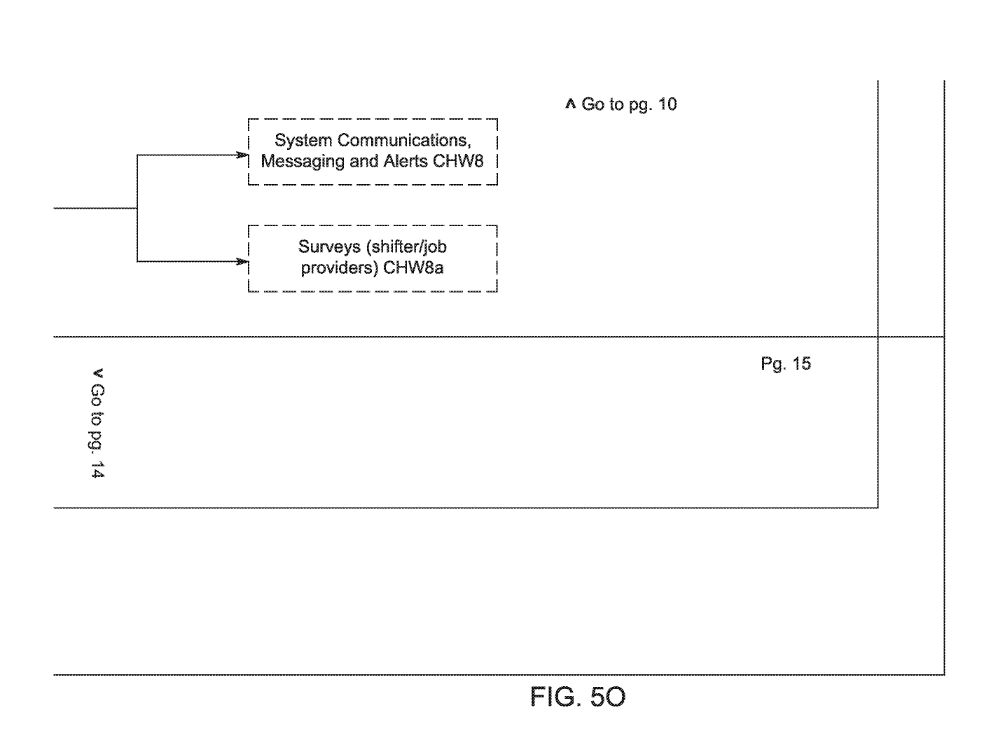

FIGS. 5 and 5A-5O show an example operational flow of the shift worker platform 400. Each of FIGS. 5A-5O is one of fifteen pieces of a large flowchart to be assembled as shown in FIG. 5. In particular, as shown in FIG. 5, the pieces are to be arranged as a first row containing FIGS. 5A, 5B, 5C, 5D, and 5E placed sequentially from left to right, a second row positioned under the first row and containing FIGS. 5F, 5G, 5H, 5I, and 5J placed sequentially from left to right, and a third row positioned under the second row and containing FIGS. 5K, 5L, 5M, 5N, and 5O placed sequentially from left to right.

FIGS. 5A-5E shows an example operational flow of the shift worker platform 400 as applied to a shifter 130. FIG. 5A shows a login step S1 and subsequent steps. Existing users (i.e. shifters 130) may have the ability to log in via a system generated email, and a communication may be sent out asking an existing user to log in and reset his password. Brand new users may create a new profile, complete an onboarding process (e.g. via a separate link), and select membership options for membership with the shift worker platform 400. Login may be via the Web, a mobile device, and/or a direct link provided by a job provider client 120 of the CEE 110. For example, an employee of the CEE 110 that is associated with a particular job provider client 120 (e.g. a siloed employee 140) may be provided with a link from their associated job provider client 120 to create an account with the shift worker platform 400. Creating the account with the shift worker platform 400 may generate a designation command designating the employee to become a shifter 130, which may be received by the shifter I/O interface 430 and used to update the employee data in the employee data storage 410 as described in relation to FIG. 4. In this way, the designation command may originate from a shifter 130 rather than a job provider client 120 as described above. As another example, a candidate for employment from outside the shift worker platform 400 and outside the CEE 110 may approach a job provider client 120 of the CEE 110 looking for work. As part of hiring the candidate, the job provider client 120 may provide the candidate with a link to create an account with the shift worker platform 400. Upon logging in, a new shifter 130 may be directed to create a profile (step S3) and complete an onboarding process that executes human resource functions (step S3a). A returning user may already have a password and other credentials, which may be used to authenticate the user. At the time of login, the shift worker platform 400 may present a default view depending on the role of the user (e.g. shifter 130 or job provider client 120). If authentication is unsuccessful, a user of the shift worker platform 400 may request a password reset.

FIG. 5B shows a home/dashboard step S2 and subsequent steps. A home screen or dashboard may present various options to the user for selection by the user, including, for example, options to view/upgrade a profile, access a calendar (e.g. shifter calendar 300), access available shifts 360, access earnings information tracked from past worked shifts, or access alerts. Viewing or upgrading a profile (step S3) may allow further access to human resource and onboarding functionality (step S3a), credentials and training modules (step S3b), live resume functionality (step S3C, see FIG. 5C), and viewing ratings and feedback (step S3d, see FIG. 5C). Accessing a calendar may take the user to a calendar interface such as the shifter calendar 300 described with respect to FIG. 3 (step S4), as well as related user interface views associated with setting availability, filtering visible available shifts 360, etc. Available shifts 360 may be accessed via the shifter calendar 300 or other interface view (e.g. list, map, etc.). A shifts process S5 is described in relation to FIG. 5C. Accessing alerts (step S7) may allow further access to surveys (S7a) and feedback and ratings functionality (S7b) in relation to job providers 120.

FIG. 5C shows a shifts process S5 (see also FIGS. 5B and 5D). The shifter 130 may request (e.g. apply for, select) an available shift 360 as described above in relation to FIGS. 3 and 4. In a case where the shifter 130 selected the shift from her shifter calendar 300, the shift worker platform 400 (e.g. the qualification checker 452 of the shift filing engine 450) may have already checked the qualifications of the shifter 130 in relation to that particular available shift 360 in order to determine whether the available shift 360 should be displayed to that shifter 130 (e.g. via the calendar updater 454). In some cases, however, such as where the shifter 130 found the available shift 360 by conducting an expansive search to fill a schedule gap 320, the shifter 130 may not be qualified for the shift. Therefore, the shift worker platform 400 (e.g. the qualification checker 452) may check the qualifications of the shifter 130 upon selection of the available shift 360. If the shifter 130 is qualified, the shift worker platform 400 may proceed with the application process (e.g. updating the job provider client calendar 200 of the relevant job provider 120). If the shifter 130 is not qualified, the shift worker platform 400 may recommend training so that the shifter 130 might become qualified, allowing the shifter 130 to browse relevant training modules.

As described above, the available shifts 360 visible to the shifter 130 (e.g. those displayed in the shifter calendar 300 or other user interface) may be the result of a matching process performed by the qualification checker 452 of the shift filling engine 450. Namely, the qualification checker 452 may search the employee data storage 410 for all shifters 130 for whom certain qualifications are met, such as i) the employee meets the minimum qualifications included in the available shift data (e.g. experience, certifications, etc.), and ii) the available shift 260 represented by the available shift data meets the preferences of the employee (e.g. geographic location, minimum pay, job description, etc.). When certain qualifications are met, the available shift 360 will be displayed to the shifter 130. However, as time goes by, these available shifts 360 may be selected by other shifters 130 and eventually filled. Therefore, the shift worker platform 400 (e.g. the calendar updater 454) may sometimes indicate not only the existence of a match but also that the shifter 130 is on a waitlist or that the available shift 360 is no longer available or for some reason unavailable to that shifter 130. In the case of the available shift 360 not being available (e.g. it is already filled and confirmed for some other shifter 130), the shifter 130 may be offered some options or suggestions going forward. In the case of a waitlist (such as when a higher priority candidate has been selected by the job provider client 120 and the job provider client 120 is awaiting confirmation from the higher priority candidate), the shifter 130 may be given options to accept or decline the waitlist. In this way, the shifter calendar 300 may tentatively reserve the shift. Remaining in a waitlist may be associated with earning rewards on the shifter's account with the shift worker platform 400.

After an available shift 360 is selected by the shifter 130 and applied for as described above, the shifter 130 may receive future notifications of the status of the application (e.g. visual updating by the calendar updater 454 of the shifter calendar 300). For example, if the job provider client 120 accepts the shifter 130 for an interview, the shifter 130 may receive information to schedule the interview by email or SMS (and/or by an updated display upon login to the shift worker platform 400). If the job provider client 120 declines the shifter 130, the shifter 130 may receive confirmation (e.g. email or SMS) that she was declined and a list of recommended training (and possibly access to recommended training modules). On the other hand, if the job provider client 120 accepts the shifter 130, the shifter 130 may receive confirmation (e.g. email or SMS) that she was accepted and a link or other mechanism for accepting/confirming the shift. If the shifter 130 finally turns down the shift, the shift worker platform 400 may issue a “thank you” email and/or recommend other available shifts 360 (see FIG. 5D). If the shifter 130 accepts/confirms the shift, the job provider client 120 may be notified via the shift worker platform 400 and both the shifter calendar 300 and the job provider client calendar 200 may be updated (e.g. by the calendar updater 454) to reflect a filled shift 210, 310 as described above.

FIG. 5D shows a human resource/onboarding step S3a. After a shift has been filled as described above, the shift worker platform 400 may support the filling out of necessary employment and other legal, regulatory, and contractual forms associated with the shifter 130 filling the shift of the job provider client 120. In some cases, for example, the shifter 130 may become a temporary employee of the job provider client 120 (e.g. as co-employer with the CEE 110) during the course of working the shift. To this end, the shift worker platform 400 may draw from the employee data storage 410 and automatically fill out the necessary employment forms for review/confirmation by the shifter 130 and/or job provider client 120. Since the employee data storage 410 may already contain all of the relevant information of the shifter 130 from an earlier onboarding process, the process of filling out forms may be streamlined and largely automated. In some cases, additional information may be needed in order for the shifter 130 to meet the legal, regulatory, or contractual requirements of working a particular shift. The shift worker platform 400 may therefore prompt the shifter 130 to upgrade her profile, e.g. to include additional background, fingerprinting, driving records, drug test results, etc.

FIG. 5E shows a scheduling step S4 (see also FIG. 5D). After step S3a, the shift worker platform 400 may continue with the scheduling process. If all requirements are met, including the completion of necessary legal, regulatory, and contractual forms in step S3a, the scheduling of the shift may be finalized, while otherwise the shifter 130 may be declined. Finalizing the scheduling of the shift may result in various additional updates to the user profile and/or shifter calendar 300 of the shifter 130, such as the generation of alerts/reminders regarding the upcoming confirmed shift, updates to a monthly cash target with recommendations to meet the target, opportunities to leave feedback or rate the shift, opportunities to request feedback or a rating from the job provider client 120, and opportunities to sign up for preferential shifts with that job provider client 120, which may depend on the total hours worked for that job provider client 120 as validated by the shift worker platform 400. The shift work platform 400 may also keep track of payday for the shift on behalf of the shifter 130 and/or the job provider client 120.

FIGS. 5F-5J shows an example operational flow of the shift worker platform 400 as applied to a job provider client 120. FIG. 5F shows a login step JPW1 and subsequent steps. As the clients of the CEE 110, the job provider clients 120 will typically already have an account with the shift worker platform 400 before logging in and may receive a communication with instructions on how to log in for the first time, e.g. via the Web. As noted above, the shift worker platform 400 may present a default view depending on the role of the user (e.g. shifter 130 or job provider client 120). A home screen or dashboard view (step JPW2) may allow access to an account view for the job provider client 120 (step JPW3).

FIG. 5G shows screens or user interface views that may be accessible from the account view, home screen, or dashboard view (see also FIG. 5B) as well as a calendar/scheduling step JPW4. In particular, the job provider client 130 may access user management tools JPW3a (see FIG. 5B), human resource/onboarding functionality JPW3b, contract management and digital signatures JPW3c, ratings and feedback JPW3d, settings JPW3e, and calendar/scheduling JPW4. The calendar/scheduling step JPW4 may provide access to user interfaces such as the calendar 200 described in relation to FIG. 2. The job provider client 120 may use such a user interface to create a monthly schedule, for example, by checking whether there are any schedule gaps 220 and filling the schedule gaps 220 using the shift worker platform 400.

FIG. 5H shows a step of posting a shift JPW5 (see also FIG. 5G). Upon noticing a schedule gap 220, the job provider client 120 may post an available shift 260, e.g. as described in relation to FIG. 2. When one or more shifters 130 applies for the available shift 260, the shift worker platform 400 may update the job provider client calendar 200 or otherwise notify the job provider client 120 as described above, e.g. using the priority evaluator 456 and the calendar updater 454 of the shift filling engine 450. The job provider client 120 may thereafter review the applicants, who may be ranked according to priority (e.g. good/better/best matches) as described above. To this end, the job provider client calendar 200 may include filter options allowing the job provider client 120 to see only a narrower subset of the candidates. This may be in addition to the filtering done by the priority evaluator 456 on the basis of the settings and private preferences set by the job provider client 120 in relation to the available shift 260. The job provider client 120 may have the option of selecting/approving one or more shifters 130 and may further have the option of creating a waitlist for other candidates. The job provider client 120 may also have the option of interviewing one or more candidates before making a selection.

FIG. 5I shows additional notifications and options that the job provider client 120 may receive or interact with using the shift worker platform 400 as scheduling of the shifter 120 for the shift proceeds. These may include, for example, the ability to sign the shifter 130 up for preferential shifts, ranking/rating the shifter 130 for future shifts, etc. As shown in FIG. 5J, the shift worker platform 400 may allow the job provider client 120 to approve payroll in relation to the filled shift.

FIGS. 5K-5O shows an example operational flow of the shift worker platform 400 as applied to an administrator or command hub of the shift worker platform 400 and an example operational flow of the shift worker platform 400 as applied to system functions of the shift worker platform 400. Looking first at the upper half of FIGS. 5K-5O, FIG. 5K shows a login step CHW1 for an administrator. An administrator of the shift worker platform 400 may log in, for example, to access accumulated data of completed shifts by shifters 130 with job provider clients 120 via a dashboard. Login (e.g. via the Web) may include receiving a proxy communication on how to log in and may allow for the creation of a new administrator profile for a new user or a login with credentials for a returning user. Upon successful authentication, the administrator may be allowed to create a profile as a job provider client 120 or a shifter 130. If authentication is unsuccessful, a password or user name reset may be issued. As noted above, the shift worker platform 400 may present a default view depending on the role of the user (e.g. administrator). FIG. 5L shows access to a job provider dashboard CHW2 and account management CHW3 with subsequent functionality (see also FIGS. 5H and 5M). Accessing a job provider dashboard CHW2 may allow the administrator access to job provider functionality including human resource and onboarding functionality CHW2a, contract management and digital signatures functionality CHW2b, and ratings and feedback functionality CHW2c. Accessing account management CHW3 may allow the administrator access to user management CHW3a (see FIG. 5H) and settings CHW3b (see FIG. 5M). FIG. 5M shows access to a shifter dashboard CHW4 and a time clock CHW5 (see also FIG. 5N). Accessing a shifter dashboard CHW4 may allow the administrator access to contract management digital signatures functionality CHW4b and ratings and feedback functionality CHW4c. Accessing time clock CHW5 may allow the administrator access to reporting CHW5a (see FIG. 5N). FIG. 5N shows access to accounting CHW6 and quality control management CHW7 (see also FIGS. 5J and 5O). Accessing accounting CHW6 may allow the administrator access to reporting CHW6a. Accessing quality control management CHW7, e.g. for training shifters 130, may allow the administrator access to system communications, messaging, and alerts CHW8 (see FIG. 5J) and surveys of shifters 130 and job providers 120 (CHW8a).

The lower half of FIGS. 5K-5O show backend processes that mirror the operational flows described above, including the processing of underlying login and profile creation, the functionality of the shift worker platform 400 in checking qualifications, notifying job provider clients 120 and shifters 130 at various stages of the processes described herein, and the processing of legal, regulatory, and contractual forms, verifications, alerts, payroll, etc.

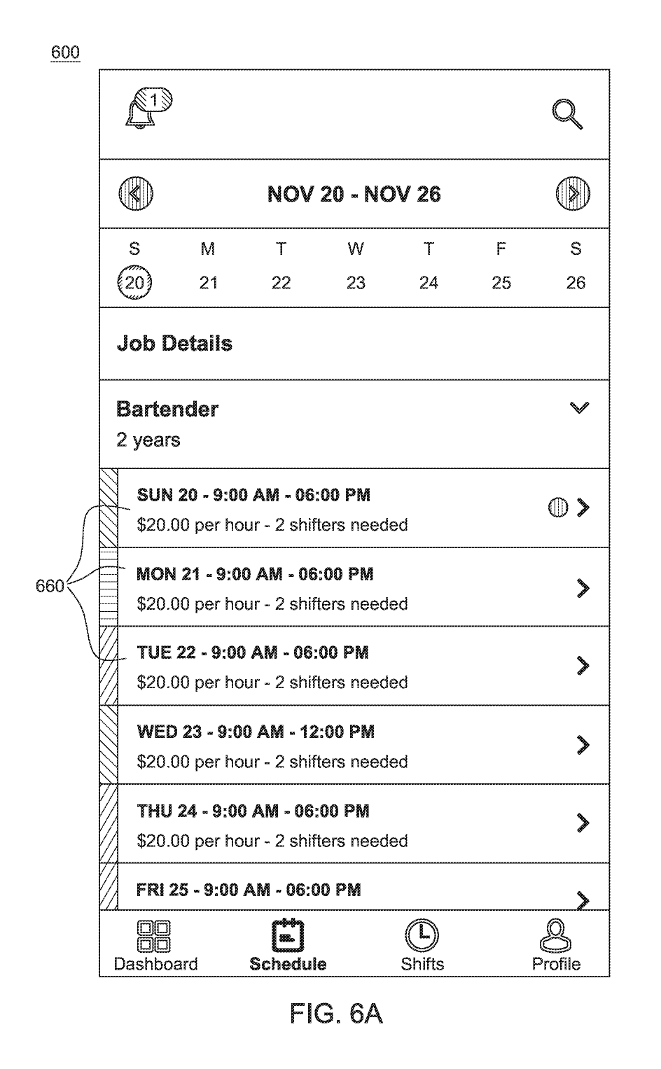

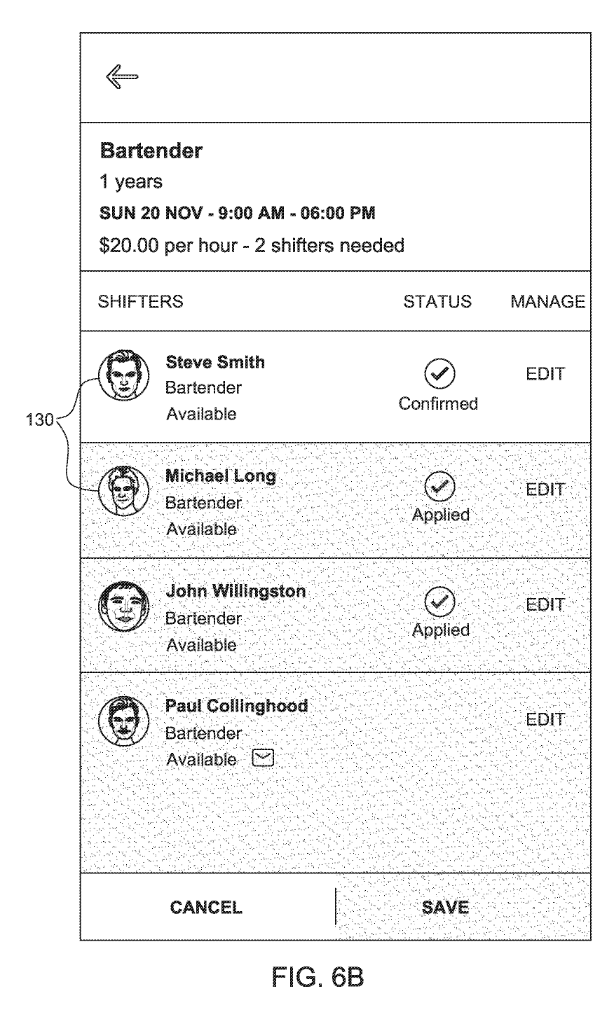

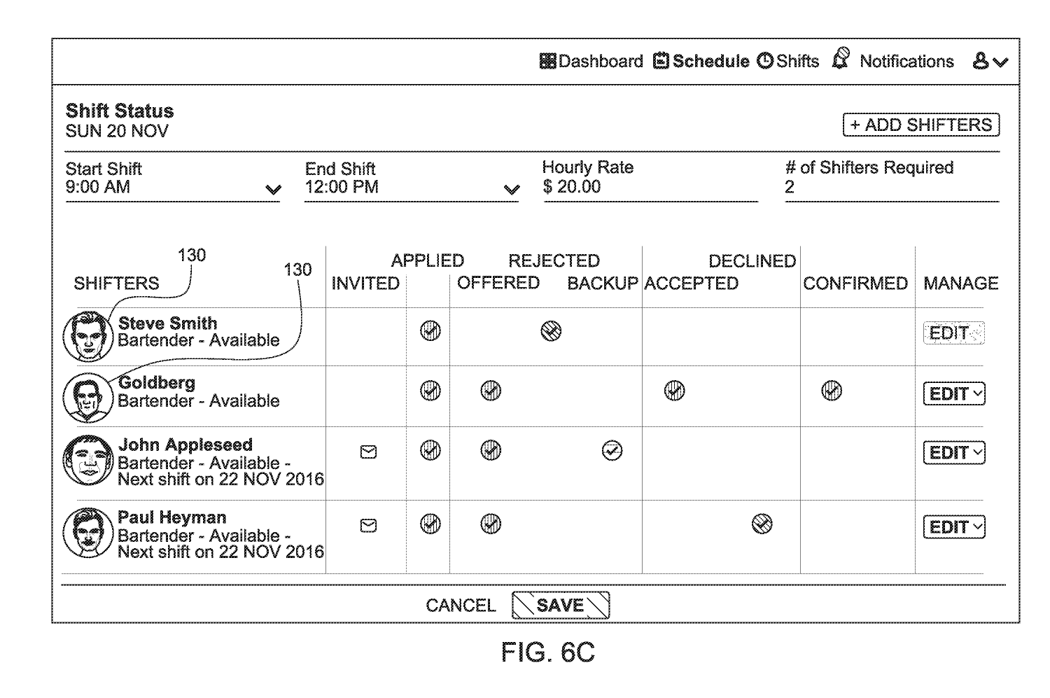

FIGS. 6A-6C show example user interface views that may be accessed by a job provider client 120 using the shift worker platform 400 according to an embodiment of the present disclosure. The user interface views shown in FIGS. 6A-6C may be additional or alternative views to the view of the job provider client calendar 200 shown in FIG. 2. FIG. 6A shows a job provider client calendar 600 arranged as a single row representing days of a week, Sunday through Saturday, for the week of November 20 to November 26. Below the row of days is a “Job Details” section, where jobs (e.g. “Bartender—2 years”) may be selected to expand into a listing of available shifts 660 of the job provider client 120. FIG. 6B shows an example user interface view that may be displayed upon the selection of one of the available shifts 660, in this case the Sunday shift of FIG. 6A. As shown in FIG. 6B, the status of candidate shifters 130 who have selected this shift (e.g. by interacting with a shifter calendar 300) can be viewed and managed. FIG. 6C shows an additional or alternative view of the user interface view shown in FIG. 6B. FIG. 6C represents an expanded view including additional details of candidate shifters 130.

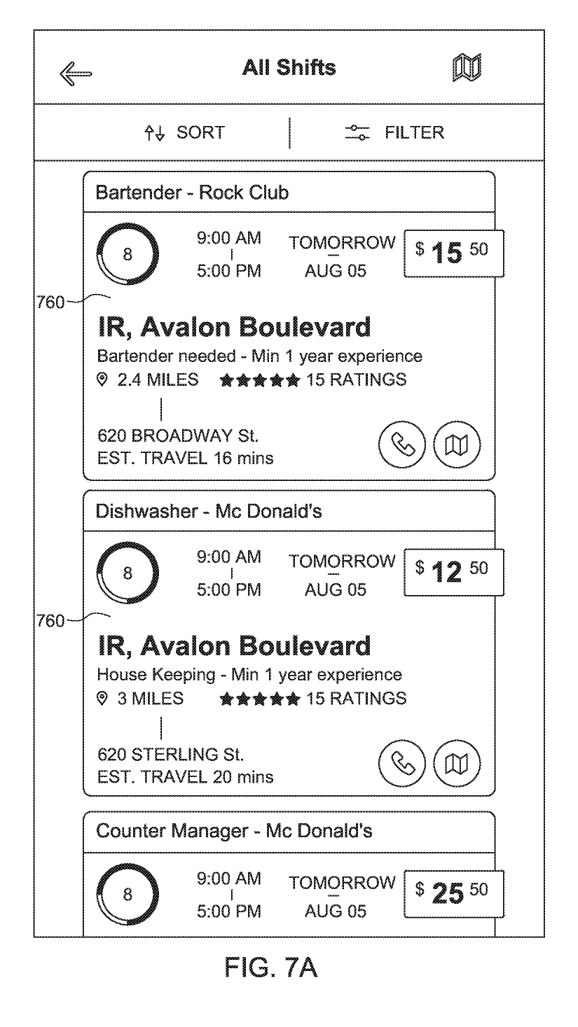

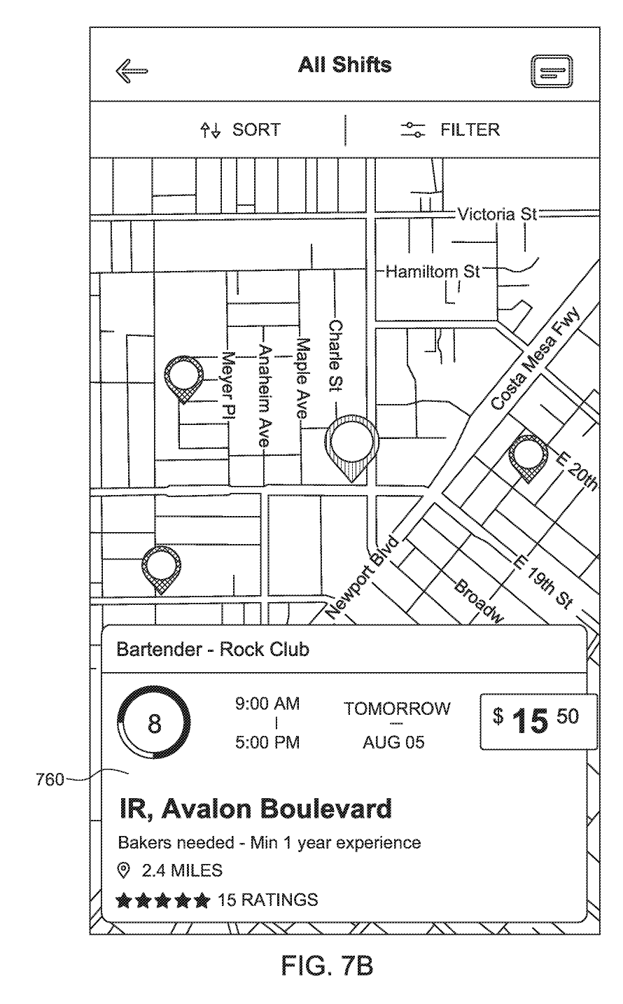

FIGS. 7A and 7B show example user interface views that may be accessed by a shifter 130. The user interface views shown in FIGS. 7A and 7B may be additional or alternative views to the view of the shifter calendar 300 shown in FIG. 3. In FIG. 7A, available shifts 760 are shown as a list. In this example, each of the available shifts 760 is for the same time slot, 9:00 AM to 5:00 PM on August 5. Displayed details of the available shifts 760 include geographic location and distance (with link to map view), amount of pay, and job description (e.g. “bartender needed—Min 1 year experience”). The list view of FIG. 7A may be presented to a shifter 130 when the shifter 130 clicks on or taps a bubble representing available shifts 360 in the shifter calendar 300 of FIG. 3. For example, the bubble indicating “3 Shifts Available!” may be expanded to a user interface as shown in FIG. 7A to allow the shifter 130 to view details of the three shifts. Alternatively, or additionally, the list view of FIG. 7A may be presented to a shifter 130 to present search results when the shifter 130 conducts an expansive search to fill a schedule gap 320 in the shifter calendar 300. For example, the shifter 130 may be primarily interested in working as a server and may have set her user profile so that only server shifts are presented by default in her shifter calendar 300. If there are no matching server shifts available for the 9:00 AM to 5:00 PM August 5 slot, her shifter calendar 300 may show a schedule gap 320. The shifter 130 may select the schedule gap 320 and expand her search to include other job descriptions besides server, resulting in search results including bartender, housekeeping, etc. as shown in FIG. 7A.

FIG. 7B shows an example user interface view that may be displayed upon the selection of a link to a map view in FIG. 7A. For example, the shifter 130 may click on, tap, etc. the words “2.4 MILES” or the adjacent map pointer icon in FIG. 7A to cause the map view of FIG. 7B to be displayed. The enlarged green map pointer icon in FIG. 7B may represent the location of the shift for which the map view link was selected, while the other map pointer icons may represent the locations of other shifts from the list view of FIG. 7A.

As noted above, the CEE 110 may be a traditional professional employer organization. Other examples of the CEE 110 may include a temporary or long term staffing company, employment contractor, employee leasing entity, employment agency, or any other entity responsible for some aspect of human resource or administrative functions on behalf of client businesses, including non-traditional entities. In the examples described throughout this disclosure, it is assumed that the CEE 110 employs the workforce of its client businesses. However, the CEE 110 need not be so limited and, in some cases, the CEE 110 may be an entity that does not act as employer, such as an administrative services organization.

The practical realities of running a business can make it overly burdensome for an employer to take on shift workers to meet the business's temporary needs. Often, for example, the time and expense of managing the legal, regulatory, and contractual aspects of taking on an employee make it inefficient for the business to hire a new employee on such a temporary and sporadic basis. The business may, as a result, pay overtime to an existing employee, resulting inefficiencies and loss for the business, or underpay part-time shift workers, making the position less competitive and reducing the quality of the hiring pool. Conventional mechanisms for outsourcing administrative duties may appear to reduce the burden, but in the end are ineffective in the case of shift work. This is because conventional mechanisms do not get at the underlying issue that, in the case of shift workers, the administrative burden must typically be duplicated for a plurality of employers, or else the shift worker cannot make a living. This creates an inherent inefficiency in shift work that eventually impacts the employer in addition to the shift worker. Namely, shift workers have difficulty finding employers who can efficiently take them on, resulting in fewer and lower quality shift workers available to the employers. The shift worker platform 400 solves this issue by creating an efficient job provider/shift worker ecosystem combining the efficiency gains associated with outsourcing administrative duties with a highly usable and streamlined system of connecting job providers with multiple shift workers and connecting shift workers with multiple job providers. By using the shift worker platform 400, job providers can find high quality workers even when they can only offer a few hours on a sporadic schedule. Since filling shifts becomes much easier and more appealing to job providers, the shift workers can more easily fill their own weeks and make a living.

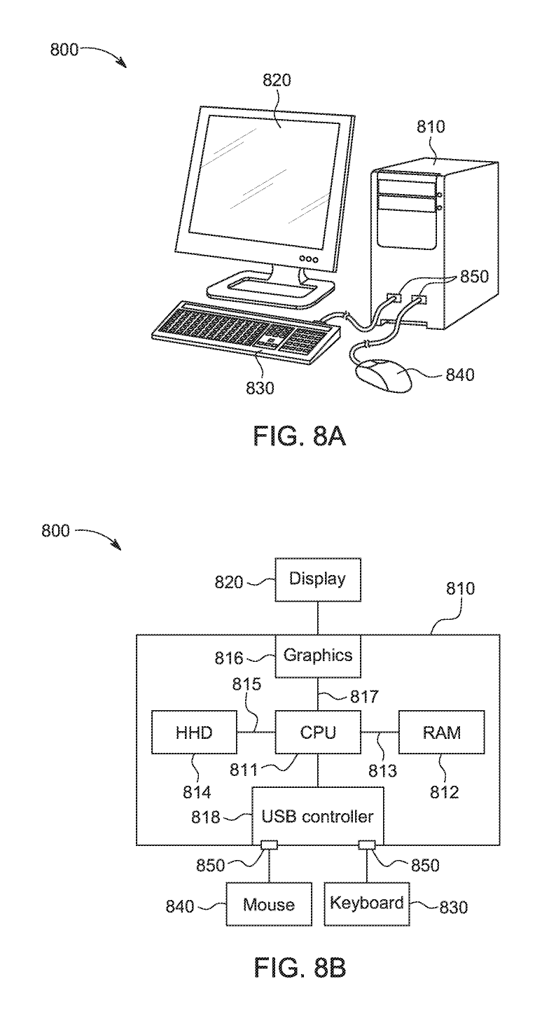

FIGS. 8A and 8B show an example of a computer 800 in which the server 160 of FIG. 1, the shift worker platform 400 of FIG. 4, the operational flows of FIGS. 5A-5O, and/or other embodiments of the claimed invention may be wholly or partly embodied. The computer 800 according to the present embodiment, as shown in FIG. 8A, generally includes a system unit 810 and a display device 820. The display device 820 produces a graphical output from the data processing operations performed by the system unit 810. Input devices including a keyboard 830 and a mouse 840, for example, may be manipulated by a user to generate corresponding inputs to the data processing operations, and are connected to the system unit 810 via ports 850. Various other input and output devices may be connected to the system unit 810, and different interconnection modalities are known in the art.

As shown in the block diagram of FIG. 8B, the system unit 810 includes a processor (CPU) 811, which may be any conventional type. A system memory (RAM) 812 temporarily stores results of the data processing operations performed by the CPU 811, and is interconnected thereto typically via a dedicated memory channel 813. The system unit 810 may also include permanent storage devices such as a hard drive 814, which is also in communication with the CPU 811 over an input/output (I/O) bus 815. A dedicated graphics module 816 may also connected to the CPU 811 via a video bus 817, and transmits signals representative of display data to the display device 820. As indicated above, the keyboard 830 and the mouse 840 are connected to the system unit 810 over the ports 850. In embodiments where the ports 850 are Universal Serial Bus (USB) type, there may be a USB controller 818 that translates data and instructions to and from the CPU 811 for the external peripherals connected via the ports 850 or wirelessly connected such as via Bluetooth connectivity. Additional devices such as printers, microphones, speakers, and the like may be connected to the system unit 810 thereby.

The system unit 810 may utilize any operating system having a graphical user interface (GUI), such as WINDOWS from Microsoft Corporation of Redmond, Wash., MAC OS from Apple, Inc. of Cupertino, Calif., various versions of UNIX with the X-Windows windowing system, and so forth. The system unit 810 executes one or more computer programs, with the results thereof being displayed on the display device 820. Generally, the operating system and the computer programs are tangibly embodied in a computer-readable medium, e.g., the hard drive 814. Both the operating system and the computer programs may be loaded from the aforementioned data storage devices into the RAM 812 for execution by the CPU 811. The computer programs may comprise instructions, which, when read and executed by the CPU 811, cause the same to perform or execute the steps or features of the various embodiments set forth in the present disclosure.

For example, a program that is installed in the computer 800 can cause the computer 800 to function as the shift worker platform 400 of FIG. 4. Such a program may act on the CPU 811 to cause the computer 800 to function as some or all of the sections, components, elements, databases, engines, interfaces, etc. of the shift worker platform of FIG. 4 (e.g., the shift filling engine 450, the qualification checker 452, etc.). A program that is installed in the computer 800 can also cause the computer 800 to perform an operational flow such as those illustrated in FIGS. 5A-5O or a portion thereof. Such a program may, for example, act on the CPU 811 to cause the computer 800 to perform one or more of the steps of FIGS. 5A-5O (e.g., “request shift” of FIG. 5C, “posts shifts available” of FIG. 5G, “reviews applicants—system ranks the candidates who applied” of FIG. 5H, etc.).

The above-mentioned program may be provided to the hard drive 814 by or otherwise reside on an external storage medium such as a DVD-ROM, optical recording media such as a Blu-ray Disk or a CD, magneto-optic recording medium such as an MO, a tape medium, a semiconductor memory such as an IC card, a mechanically encoded medium such as a punch card, etc. Additionally, program storage media can include a hard disk or RAM in a server system connected to a communication network such as a dedicated network or the Internet, such that the program may be provided to the computer 800 via the network. Program storage media may, in some embodiments, be non-transitory, thus excluding transitory signals per se, such as radio waves or other electromagnetic waves.

Instructions stored on a program storage medium may include, in addition to code executable by a processor, state information for execution by programmable circuitry such as a field-programmable gate arrays (FPGA) or programmable logic array (PLA).

Although certain features of the present disclosure are described in relation to a computer 800 with input and output capabilities including a keyboard 830 and mouse 840, specifics thereof are presented by way of example only and not of limitation. Any alternative graphical user interfaces such as touch interfaces and pen/digitizer interfaces may be substituted. The analogs of those features will be readily appreciated, along with suitable modifications to accommodate these alternative interfaces while still achieving the same functionalities.

Along these lines, the foregoing computer 800 represents only one exemplary apparatus of many otherwise suitable for implementing aspects of the present disclosure, and only the most basic of the components thereof have been described. It is to be understood that the computer 800 may include additional components not described herein, and may have different configurations and architectures. Any such alternative is deemed to be within the scope of the present disclosure.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A non-transitory program storage medium on which are stored instructions executable by a processor or programmable circuit to perform operations comprising:
receiving a shifter designation command designating an employee from among a plurality of employees of a common employer entity to become one of a plurality of shifters;
receiving available shift data generated by user interaction with an interactive job provider client calendar, the available shift data representing an available work shift of one of a plurality of job provider clients of the common employer entity;
establishing one or more matches between the available shift data and the plurality of shifters;
updating an interactive shifter calendar of each of the plurality of shifters for whom a match was established to include a visual representation of the available work shift;
receiving shift selection data generated by user interaction with the shifter calendar of a first shifter of the plurality of shifters for whom a match was established, the shift selection data including a selection of the available work shift by the first shifter; and
updating the job provider client calendar to include a visual representation of the selection by the first shifter.

2. The non-transitory program storage medium of claim 1, wherein the establishing includes checking, for each of the plurality of shifters, whether the shifter meets a qualification associated with the available shift data.

3. The non-transitory program storage medium of claim 1, wherein the establishing includes checking, for each of the plurality of shifters, whether the available work shift meets a qualification associated with the shifter.

4. The non-transitory program storage medium of claim 1, wherein the establishing includes checking, for each of the plurality of shifters, whether the shifter meets a qualification associated with the available shift data and whether the available work shift meets a qualification associated with the shifter.

5. The non-transitory program storage medium of claim 1, further comprising:
receiving shifter selection data generated by user interaction with the job provider calendar, the shifter selection data including a selection of the first shifter to fill the available work shift; and
updating the shifter calendar of the first shifter to include a visual representation of the selection of the first shifter to fill the work shift.

6. The non-transitory program storage medium of claim 5, further comprising:
receiving shifter confirmation data generated by user interaction with the shifter calendar of the first shifter, the shifter confirmation data including a confirmation that the first shifter will fill the available work shift; and
updating the job provider calendar to include a visual representation of the confirmation.

7. The non-transitory program storage medium of claim 1, further comprising:
receiving shift selection data generated by user interaction with the shifter calendar of a second shifter of the plurality of shifters for whom a match was established, the shift selection data including a selection of the available work shift by the second shifter; and
evaluating a priority between the first shifter and the second shifter.

8. The non-transitory program storage medium of claim 7, further comprising updating the job provider client calendar to include a visual representation of the selection by the second shifter and an indication of the priority between the first shifter and the second shifter.

9. The non-transitory program storage medium of claim 8, further comprising:
receiving shifter selection data generated by user interaction with the job provider calendar, the shifter selection data including a selection of the first shifter to fill the available work shift and a selection of the second shifter to be waitlisted;
updating the shifter calendar of the first shifter to include a visual representation of the selection of the first shifter to fill the available work shift; and
updating the shifter calendar of the second shifter to include a visual representation of the selection of the second shifter to be waitlisted.

10. The non-transitory program storage medium of claim 9, further comprising:
receiving shifter withdrawal data generated by user interaction with the shifter calendar of the first shifter, the shifter withdrawal data including a withdrawal from consideration for the available work shift by the first shifter; and
updating the shifter calendar of the second shifter to include a visual representation of the selection of the second shifter to fill the available work shift.

11. The non-transitory program storage medium of claim 9, further comprising:
receiving shifter withdrawal data generated by user interaction with the shifter calendar of the first shifter, the shifter withdrawal data including a withdrawal from consideration for the available work shift by the first shifter; and
updating the job provider calendar to include a visual representation of the withdrawal.

12. The non-transitory program storage medium of claim 11, further comprising:
receiving revised shifter selection data generated by user interaction with the job provider calendar, the revised shifter selection data including a selection of the second shifter to fill the available work shift; and
updating the shifter calendar of the second shifter to include a visual representation of the selection of the second shifter to fill the available work shift.

13. The non-transitory program storage medium of claim 1, further comprising:
receiving a search request from a third shifter of the plurality of shifters, the search request indicating a temporary relaxing of the qualifications associated with the third shifter.

14. The non-transitory program storage medium of claim 1, further comprising:
receiving a filter request from a third shifter of the plurality of shifters, the filter request indicating a temporary tightening of the qualifications associated with the third shifter.

15. The non-transitory program storage medium of claim 1, wherein the common employer entity is the sole employer of the plurality of employees.

16. The non-transitory program storage medium of claim 1, wherein the common employer entity handles, on behalf of the plurality of job provider clients, one or more employee management responsibilities from the group consisting of payroll, human resources, overtime management, Affordable Care Act compliance, and workers' compensation.

17. The non-transitory program storage medium of claim 1, wherein the common employer entity is a professional employer organization.

18. The non-transitory program storage medium of claim 1, wherein the common employer entity is a temporary or long term staffing company, employment contractor, employee leasing entity, or employment agency.

19. A method comprising:
receiving a shifter designation command designating an employee from among a plurality of employees of a common employer entity to become one of a plurality of shifters;
receiving available shift data generated by user interaction with an interactive job provider client calendar, the available shift data representing an available work shift of one of a plurality of job provider clients of the common employer entity;
establishing one or more matches between the available shift data and the plurality of shifters;
updating an interactive shifter calendar of each of the plurality of shifters for whom a match was established to include a visual representation of the available work shift;
receiving shift selection data generated by user interaction with the shifter calendar of a first shifter of the plurality of shifters for whom a match was established, the shift selection data including a selection of the available work shift by the first shifter; and
updating the job provider client calendar to include a visual representation of the selection by the first shifter.

20. A system comprising:
a job provider I/O interface for receiving a shifter designation command designating an employee from among a plurality of employees of a common employer entity to become one of a plurality of shifters and receiving available shift data generated by user interaction with an interactive job provider client calendar, the available shift data representing an available work shift of one of a plurality of job provider clients of the common employer entity;
a server for establishing one or more matches between the available shift data and the plurality of shifters and updating an interactive shifter calendar of each of the plurality of shifters for whom a match was established to include a visual representation of the available work shift; and
a shifter I/O interface for receiving shift selection data generated by user interaction with the shifter calendar of a first shifter of the plurality of shifters for whom a match was established, the shift selection data including a selection of the available work shift by the first shifter, wherein
the server updates the job provider client calendar to include a visual representation of the selection by the first shifter.
